(19) United States
(12) Patent Application Publication
(10) Pub. No.: US 2009/0199747 A1
(43) Pub. Date: Aug. 13, 2009

(54) BIOMASS BURNER SYSTEM

(75) Inventors: Scott M. Laskowski, Madisonville, KY (US); Johann G. Duerichen, Madisonville, IN (US); Timothy W. Baughman, Madisonville, KY (US)

Correspondence Address: BARNES & THORNBURG LLP, 11 SOUTH MERIDIAN, INDIANAPOLIS, IN, 46204, US

(73) Assignee: WOOD-MIZER PRODUCTS, INC., Indianapolis, IN (US)

(21) Appl. No.: 12/175,058

(22) Filed: Jul. 17, 2008

Related U.S. Application Data
(60) Provisional application No. 61/027,277, filed on Feb. 8, 2008.

(51) Int. Cl. F23N 1/02; F23G 5/24; F23N 5/02; F27D 1/10; F27B 1/18; F27B 1/22; F23J 1/06

(52) U.S. Cl. 110/186; 110/235; 110/336; 110/259; 110/258; 110/190

(57) ABSTRACT

A biomass burner system includes a burner assembly, a fuel storage assembly coupled to the burner assembly, and a heat exchanger configured to receive the heat from the burner assembly. The biomass burner system includes a controller which is programmable to monitor various operating conditions of the biomass burner and control the operation of the biomass burner to confirm safe and efficient operation. The controller is operable to monitor a temperature associated with the combustion chamber, a temperature associated with the heat exchanger, and a temperature associated with the air exiting the system. The biomass burner system is operable to vary the flow of air into the combustion chamber, the flow of fuel into the combustion chamber, the operation of an igniter system to maintain the efficient operation of the biomass burner system.

This application claims priority under 35 U.S.C. §119(e) to U.S. Provisional Application Ser. No. 61/027,277, filed Feb. 6, 2008, which is expressly incorporated by reference herein.

### BACKGROUND OF THE INVENTION

The present disclosure is related to a system which burns waste product to fuel a heat exchanger. More specifically, the present disclosure is related to a waste burner system including a closed-feedback control system to control the rate of fuel feed and combustion air.

The use of biomass such as wood chips, sawdust, bark and the like as a fuel for a furnace or other heating system is known. Such systems are known to employ a variety of fuel feed systems to feed fuel material into a combustion area or chamber. Such systems employ a variety of methods to prepare the fuel for combustion. For example, fuel may be fed from overhead storage such that the fuel falls onto a hearth or grate, the heat of combustion tending to dry the fuel as it falls. In other case, fuel may be dried by a forced air drier prior to feeding. Forced air drying may include the use of hot air from the combustion process to dry or pre-heat the fuel particles.

Variations in the moisture content of the fuel cause variations in combustion efficiency which, in turn, results in variations in emissions from the burner. Control of the combustion process to account for variations in the characteristics of the fuel is limited and systems are often implemented which consume energy in the form of additional air flow or pre-heating processes which impact the overall efficiency of the system.

### SUMMARY OF THE INVENTION

According to the present disclosure, a biomass burner system comprises one or more of the features recited in the appended claims and/or the following features which, alone or in any combination, may comprise patentable subject matter:

The biomass burner system may comprise a burner assembly, a fuel storage assembly, a heat exchanger, and a control system. The burner assembly may include a combustion chamber, first and second air tubes in communication with the combustion chamber. A first blower may be coupled to the first air tube and configured to provide a variable flow of air to the combustion chamber. A second blower may be coupled to the second air tube and configured to provide a variable flow of air to the combustion chamber.

In some embodiments, the burner assembly combustion chamber may include a base and a generally cylindrical wall extending vertically from the base. The generally cylindrical wall may define a generally vertical axis. The generally cylindrical wall and the base may cooperate to define a combustion space. The burner assembly may further include a generally funnel-shaped cover. The cover may be positioned such that an end of the generally funnel-shaped cover having a larger diameter is supported on the generally cylindrical wall of the combustion chamber. When the cover is positioned, a smaller diameter of the generally funnel-shaped cover may be positioned in the combustion space. The smaller diameter may define an aperture through which exhaust gases are vented.

In some embodiments, an interior portion of the generally cylindrical wall is lined with a ceramic material. The interior surface of the ceramic material may be formed to include a plurality of generally planar surfaces. Each generally planar surface may be generally parallel to the axis of the generally cylindrical wall such that each planar surface intersects an adjacent generally planar surface. The generally planar surfaces may be configured such that the interior generally vertical surface of the combustion chamber is a discontinuous surface.

The burner assembly may further comprise a sensor positioned adjacent the generally cylindrical wall, the sensor operable to provide a signal indicative of the temperature of the generally cylindrical wall to the controller.

The base of the combustion chamber may be formed to include an aperture. In some embodiments, the burner assembly may further comprise an ash auger. The aperture in the base may communicate between the combustion space and the ash auger such that the ash auger is operable to remove ash from the combustion chamber. The ash auger may operate intermittently. The ash auger may be configured to maintain ash in the auger to prevent air from flowing through the ash auger into the combustion chamber. The controller may be operable to control the operation of the ash auger.

The burner assembly may further comprise an ash stirrer configured to rotate within the combustion chamber to expose uncombusted fuel and move ash to the aperture in the base. The controller may be operable to control the operation of the ash stirrer.

The first air tube may be configured to communicate air from outside of the combustion chamber to the combustion space. The first air tube may define a longitudinal axis oriented in a generally horizontal plane. The first air tube may be positioned such that the longitudinal axis of the first air tube is parallel to a line that intersects the generally vertical axis of the generally cylindrical wall, and be spaced horizontally apart from the generally vertical axis of the generally cylindrical wall. When the first air tube is positioned such that the axis is spaced apart from the vertical axis of the combustion chamber, the air introduced by the first air tube may induce a swirling flow of air within the combustion chamber.

The first blower may be coupled to the first air tube and may be configured to provide a variable flow of air through the first air tube to the combustion space. The control system may be operable to vary the speed of the first blower.

The second air tube may be configured to communicate air from outside of the combustion chamber to the combustion space. The second air tube may define a longitudinal axis oriented in a generally horizontal plane. The second air tube may be positioned such that the longitudinal axis of the second air tube is parallel to a line that intersects the generally vertical axis of the generally cylindrical wall. The second air tube may be spaced horizontally apart from the generally vertical axis of the generally cylindrical wall. When the second air tube is positioned such that the axis is spaced apart from the vertical axis of the combustion chamber, the air introduced by the second air tube may induce a swirling flow of air within the combustion chamber.

The second blower may be coupled to the second air tube and configured to provide a variable flow of air through the second air tube to the combustion space. The control system may be operable to vary the speed of the second blower.

In some embodiments, a nozzle may be positioned in the second air tube and configured to disrupt the flow of air in the second air tube to create a generally chaotic air flow. Also, embodiments of the burner assembly may include a fuel feeder coupled to the second air tube and positioned to introduce fuel to the second air tube at point where the flow of air has been disrupted by the nozzle.

In some embodiments, the fuel storage assembly may be coupled to the burner assembly and configured to provide a flow of fuel to the second air tube. In some embodiments, the fuel storage assembly includes a fuel storage hopper, a fuel auger in communication with the fuel storage hopper and configured to convey fuel from the fuel storage hopper to the second air tube of the burner assembly.

The heat exchanger may be supported on the burner assembly and include a fluid-tight vessel. The vessel may be formed such that a plurality of tubes extend through the vessel to communicate exhaust gases from the burner assembly through the tubes to a flue. The vessel may be configured as a fluid reservoir including an inlet and an outlet through which a fluid is passed such that the fluid material receives heat through the walls of the tubes by conduction.

The controller may be operable to coordinate the operation of the blowers and the fuel auger to maintain combustion of the fuel in the combustion chamber. The controller may be operable to control the fuel feeder to vary the mass of fuel fed to the combustion chamber.

The control system may include a first temperature sensor for measuring a temperature at the exhaust gas exit of the burner assembly. The control system may also include a second temperature sensor for measuring a temperature of the ceramic wall. The control system may still also include a third temperature sensor for measuring a temperature of the fluid in the heat exchanger. The control system may yet still include a fourth temperature sensor for measuring a temperature of the exhaust gas at the gas exit of the heat exchanger. The control system may also include an ignition system including a burner and a variable speed combustion blower for providing combustion air to the combustion chamber. The variable speed combustion blower may be configured as the first blower.

The control system may be operable to measure the temperature of the ceramic material and to start the burner of the ignition system if the ceramic temperature is below a predetermined set-point temperature. The control system may also be operable to measure the temperature of the heat exchanger fluid and to vary the flow of fuel to the combustion chamber by varying the speed of the fuel feed motor. The control system may also be further operable to vary the speed of the fuel feed blower to vary the flow of fuel to the combustion chamber.

The control system may be operable to independently compare the temperature sensed by each of the first, second, third, and fourth temperature sensors to respective safe limit temperatures and to stop the flow of fuel, the flow of combustion air, and the operation of the ignition system if any of the temperatures exceed a respective safe limit.

In some embodiments, the control system may be configured to allow a user to select a predefined operating routine based on characteristics of the fuel being used and to control the operation of the biomass burner system based on the parameters of the operating routine. Various recipes of operating parameters may be preprogrammed into the controller to establish the operating parameters for various types and conditions of fuel such that a user can select a preprogrammed recipe for operation of the system.

The system may include a hard-wired temperature sensor which shuts down the operation of the system if the temperature of the gas exiting the burner assembly is too hot.

Additional features, which alone or in combination with any other feature(s), including those listed above and those listed in the claims, may comprise patentable subject matter and will become apparent to those skilled in the art upon consideration of the following detailed description of illustrative embodiments exemplifying the best mode of carrying out the invention as presently perceived.

### BRIEF DESCRIPTION OF THE DRAWINGS

The detailed description particularly refers to the accompanying figures in which:

FIG. 1 is a perspective view of a biomass burner system according to the present disclosure, the biomass burner system including a burner assembly, a fuel storage assembly coupled to the burner assembly, and a heat exchanger supported on the burner assembly;

FIG. 2 is a top view of the biomass burner system of FIG. 1;

FIG. 3 is a bottom view of the biomass burner system of FIG. 1;

FIG. 4 is a plan view of the fuel storage assembly of FIG. 1;

FIG. 5 is a cross-sectional view of the fuel storage assembly of FIG. 4 taken along lines 5-5;

FIG. 6 is an enlarged view of the portion of the cross-section shown in FIG. 5 and included within the circle 6;

FIG. 7 is a perspective view of a burner assembly shown in FIG. 1;

FIG. 8 is a plan view of the burner assembly of FIG. 7;

FIG. 9 is a cross-sectional view of the burner assembly shown in FIG. 8 taken along the lines 9-9;

FIG. 10 is an enlarged view of the portion of the cross-sectional view of FIG. 9 enclosed in circle 10;

FIG. 11 is another plan view of the burner assembly of FIG. 1;

FIG. 12 is a cross-sectional view of the burner assembly as shown in FIG. 11 taken along lines 12-12;

FIG. 13 is yet another plan view of the burner assembly of FIG. 1;

FIG. 14 is a cross-sectional view of the burner assembly shown in FIG. 13 take along lines 14-14;

FIG. 15 is an enlarged view of the portion of the burner assembly enclosing circle 15 of FIG. 14;

FIG. 16 is a top view of the burner assembly of FIG. 1, the burner assembly including a volume of ash in a combustion chamber of the burner assembly;

FIG. 17 is a cross-sectional view of the burner shown in FIG. 16, the cross-section taken along lines 17-17;

FIG. 18 is a perspective view of the heat exchanger of FIG. 1 with portions removed;

FIG. 19 is a bottom view of the heat exchanger shown in FIG. 18;

FIG. 20 is a side view of the heat exchanger shown in FIG. 18;

FIG. 21 is a cross-sectional view of the heat exchanger of FIG. 20, the cross-section taken along lines 21-21;

FIG. 22 is an enlarged view of the portion of the heat exchanger enclosed in circle 22 as shown in cross-sectional view 21;

FIG. 23 is a side view of the heat exchanger and burner assembly of FIG. 1;

FIG. 24 is a cross-sectional view of the heat exchanger and burner assembly shown in FIG. 23, the cross-section take along lines 24-24;

FIG. 25 is an enlarged view of the portion of the cross-section shown in FIG. 24 enclosed in circle 25;

FIGS. 26-32 is a schematic of the electrical system of the biomass burner system shown in FIG. 1;

FIG. 33A-B is a flow chart depicting the operation of a control routine which monitors the temperature in various portions of the biomass burner system of FIG. 1 to assure various portions of the system do not overheat;

FIG. 34A-B is a flow chart depicting the operation of a recipe selection routine of the biomass burner system of FIG. 1;

FIG. 35A-B is a flow chart depicting the operation of a control routine controlling the operation of an igniter of the biomass burner system of FIG. 1;

FIG. 36 is a flow chart depicting the setting of various control temperatures at which the igniter of the biomass burner system of FIG. 1 is turned on and/or off; and

FIG. 37 is a perspective view of a piece of ceramic refractory material lining the combustion chamber of the burner assembly of FIG. 16.

### DETAILED DESCRIPTION OF THE DRAWINGS

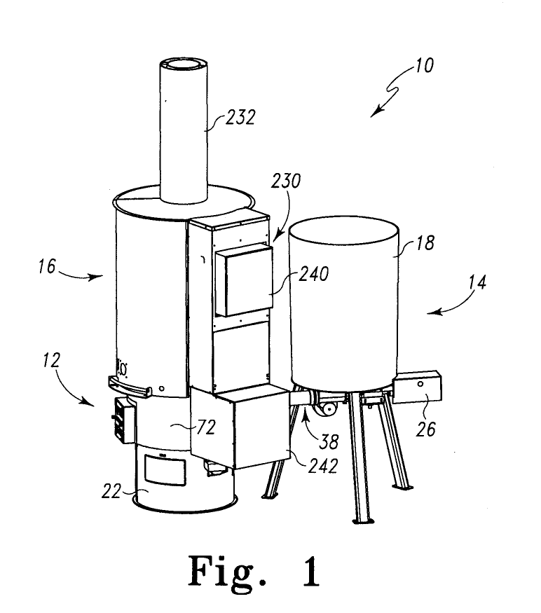

A biomass burner system 10 according to the present disclosure and shown in FIG. 1, includes a burner assembly 12, a fuel storage assembly 14 coupled to the burner assembly 12 and configured to selectively feed fuel to the burner assembly 12. A heat exchanger 16 coupled to the burner assembly 12 and positioned vertically above the burner assembly 12 such that heat from a combustion process in the burner assembly 12 rises through the heat exchanger 16 to heat a liquid passing through the heat exchanger and used for other purposes.

System 10 is configured such that various materials may be utilized as a source of fuel for the combustion process. The system 10 is electronically controlled to monitor various operational parameters to control the combustion process. Utilizing closed-loop feedback, the system 10 is responsive to operating conditions to optimize the efficiency of the combustion process and reduce the emissions from the burner assembly 12. The closed-loop feedback system includes several operational recipes which may be selected by a user to configure the system operating parameters based on the type and condition of the materials used for the fuel. Thus, control of the system 10 is automated.

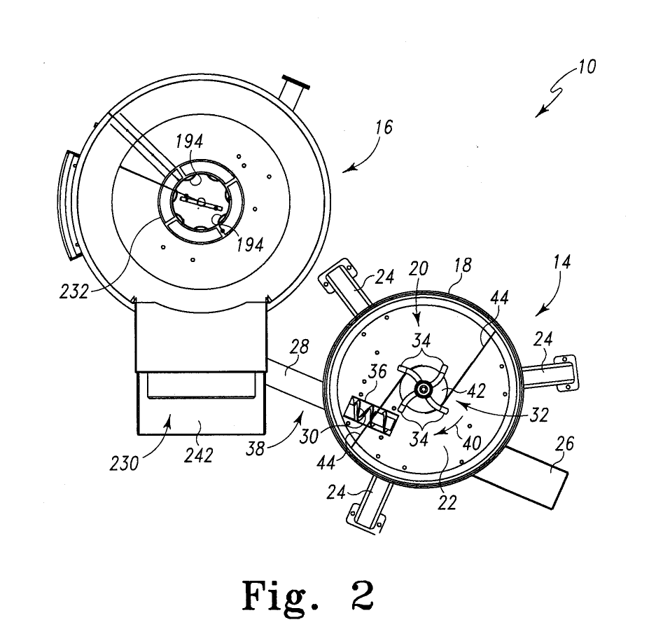

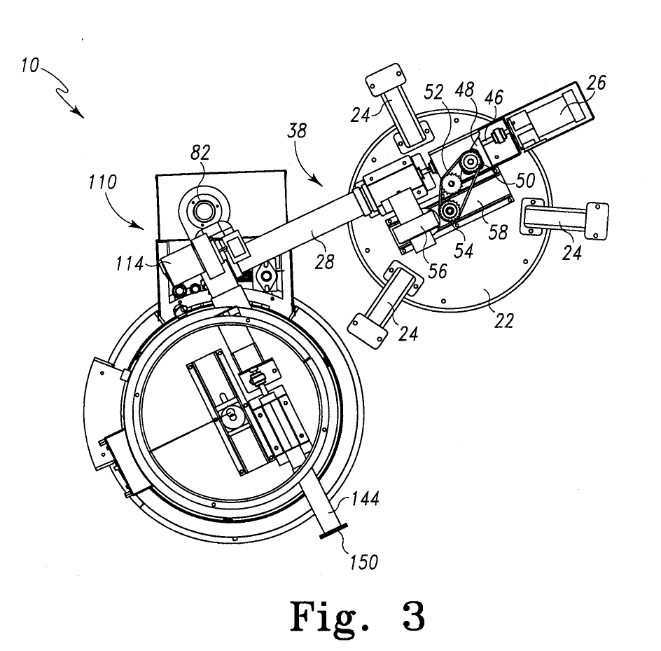

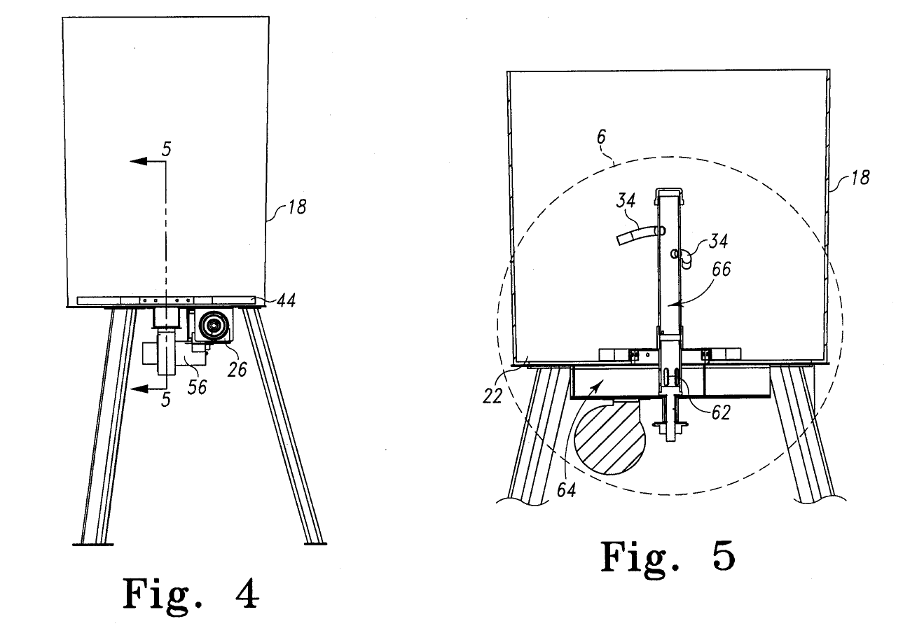

As shown in FIGS. 2-6, fuel storage assembly 14 includes a hopper 18 defining a storage space 20 in which raw fuel is stored. A bottom surface 22 of hopper 18 is supported on three legs 24. The bottom surface 22 is formed to include an aperture 36. Aperture 36 communicates to a fuel auger 38 which includes an auger tube 28 in which an auger 30 is turned by a fuel auger motor 26 to feed fuel from the hopper 18 to the burner assembly 12. In the illustrative embodiment, motor 26 is a 230 VAC, 3 HP motor operating at 30 RPM and 0.72 amps. An aerator assembly 32 is positioned in the storage space 20 and rotates as indicated by an arrow 40. Aerator assembly 32 includes four arms which extend from a hub 42. Hub 42 is driven by the feed auger motor 26 which drives a shaft 46 which is an input to a gearbox 48. A gearbox 48 drives aerator assembly 32 coupled to aerator assembly 32 through a chain assembly 45. Chain assembly 45 is driven by a drive sprocket 50 and is engaged with an idler sprocket 52. Rotation of chain assembly 44 transmits rotary motion to a driven sprocket 54 coupled to the aerator assembly 32.

A blower 56 is coupled to a plenum 58 and operable to provide a flow of air into plenum 58. Aerator assembly 32 includes a tubular shaft 60 which extends vertically upwardly from based 22 of hopper 18. Hub 42 is coupled to tubular shaft 60 such that hub 42 and tubular shaft 60 rotate as fuel auger motor 26 rotates. Tubular shaft 60 includes a plurality of apertures 62 which provide communication between an interior space 64 of Plenum 58 and interior spaces 66 of tubular shaft 60. Thus, as blower 56 provides a flow of air into Plenum 58, the air flows from interior space 64 of Plenum 58 into interior space 66 of tubular shaft 60. Aerator arms 34 are coupled to tubular shaft 60 such that air which enters into interior space 66 of tubular shaft 60 exhausts through aerator arms 34. When fuel is positioned in the storage space 20 of hopper 18, air flowing from lower 56 and exiting aerator arms 34 tends to dry the fuel stored in the storage space 20. Also, the aerator arms 34 act on the fuel as the aerator arms rotate with tubular shaft 60 to mix the fuel and reduce the potential for localized drying. Additionally, two stirrer blades 44 are coupled to hub 42 in rotate with tubular shaft 60. Stirrer blades 44 move across an upper surface 68 of base 22 of hopper 18. In addition to mixing and stirring fuel in cooperation with aerator arms 34, stirrer blades 44 move fuel across base 22 such that fuel is introduced to aperture 36 to be gathered by fuel auger 38 and fed to burner assembly 12.

As will be discussed in more detail below, the operation of blower 56 and fuel auger motor 26 is controlled by a central control system 310 of burner system 10.

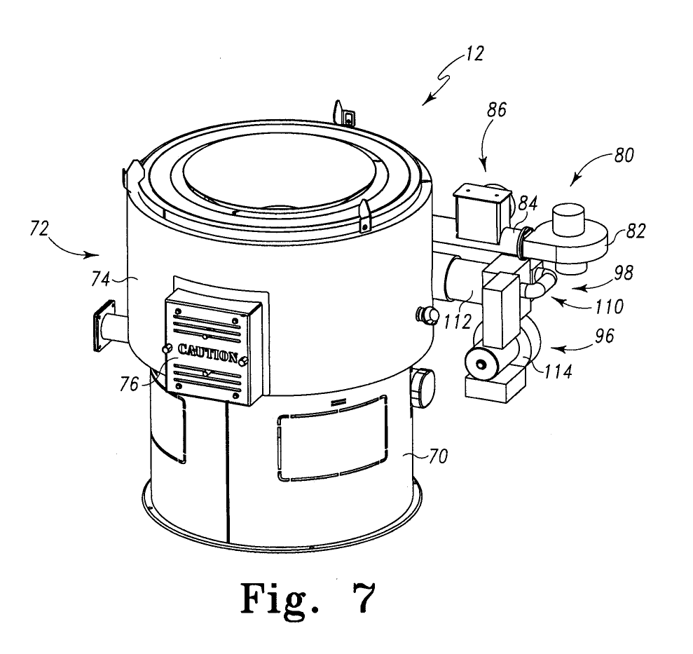

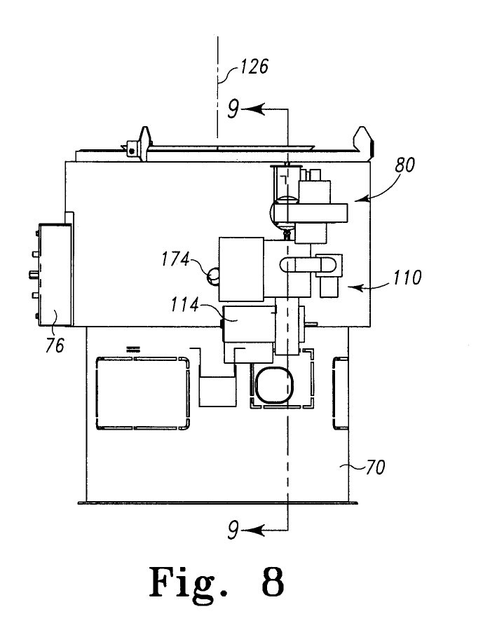

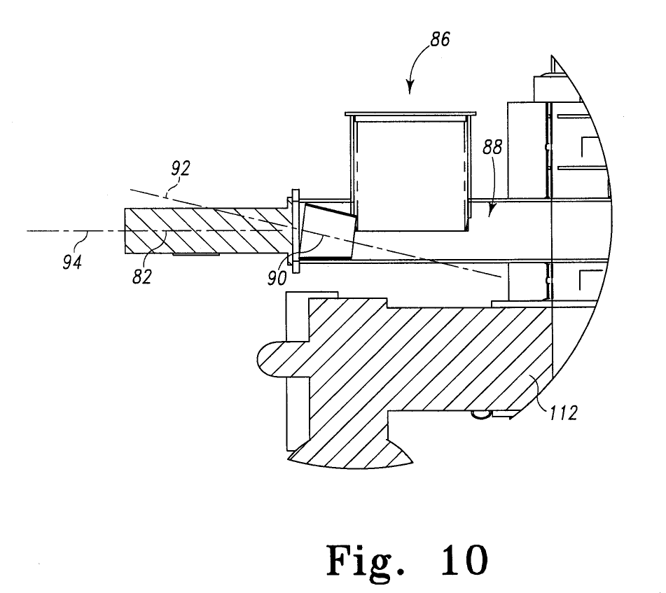

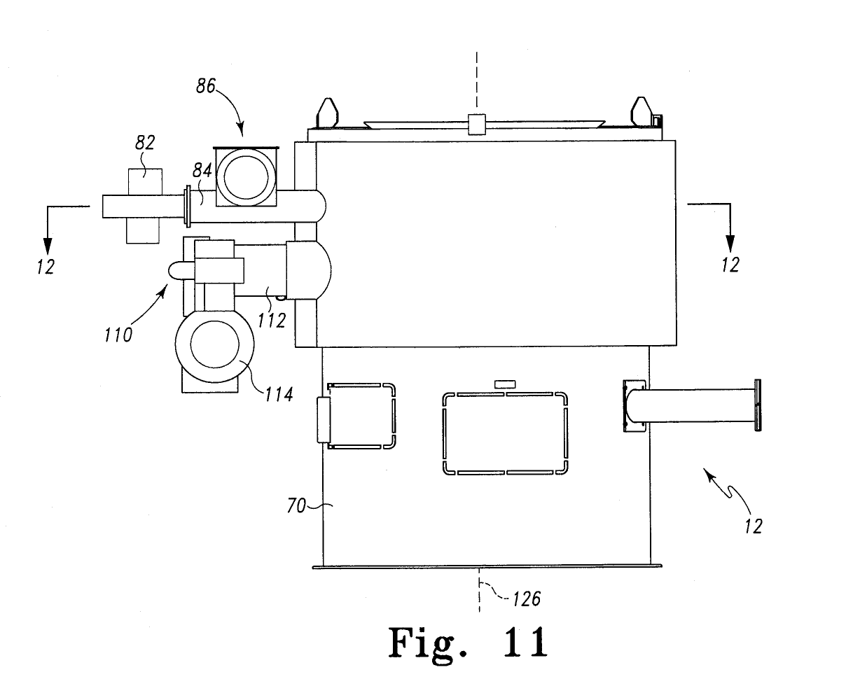

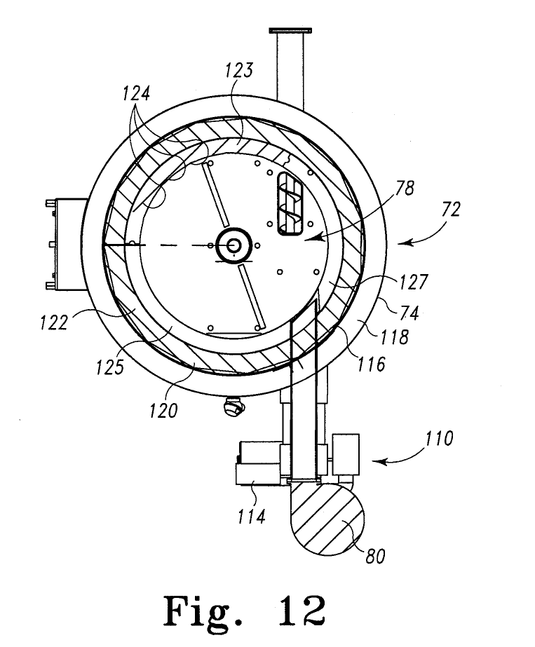

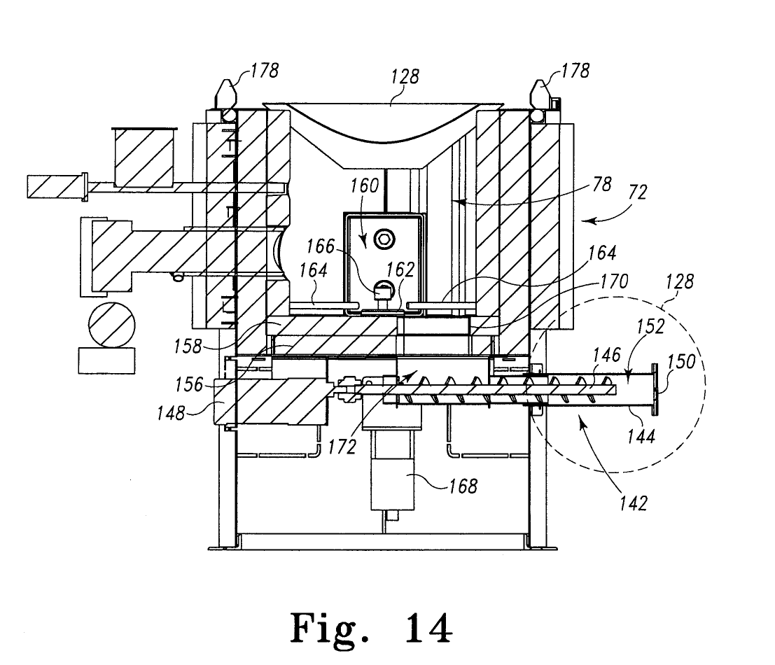

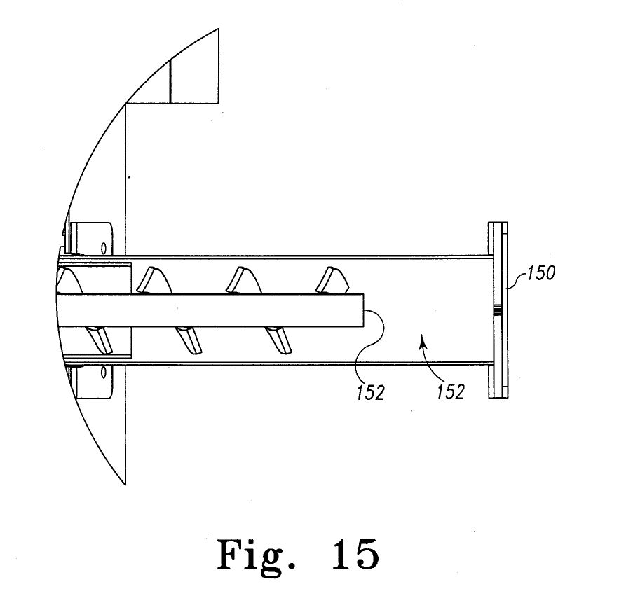

Referring now to FIG. 7-17, burner assembly 12 includes a base 70 and a combustion chamber 72 supported on the base 70. As shown in FIG. 12, combustion chamber 72 has a generally cylindrical outer wall 74 and a cover 76. In access cover 76 is removed or secured to outer wall 74 and when removed provides access to an interior space 78 of combustion chamber 72. A fuel feed assembly 80 is coupled to combustion chamber 72 and is configured to be coupled to fuel auger 38 of fuel storage assembly 14 to receive fuel their from. Fuel feed assembly 80 includes a fuel feed blower 82 coupled to an air tube 84 and a fuel feed inlet 86 coupled to air tube 84.

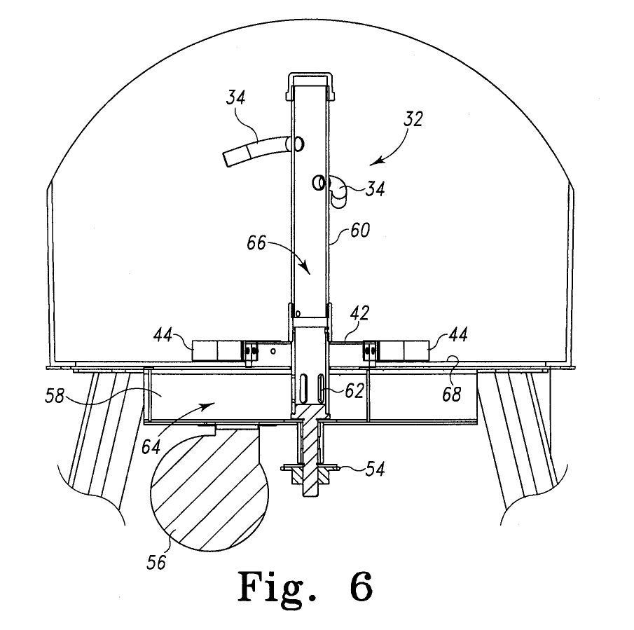

Referring now to FIGS. 6-8, the fuel feed inlet 86 is positioned downstream from blower 82 such that fuel which is fed into air tube 84 is deposited into an interior space 88 of air tube 84 and fed by the flow of air from blower 82 into the interior space 78 of combustion chamber 72. Fuel feed assembly 80 further includes a nozzle 90 positioned in the interior space 88 of air tube 84 between the blower 82 and the fuel feed inlet 86. Nozzle 90 is oriented such that the access 92 of nozzle 90 is obtuse to an axis 94 of air tube 84. The flow of air from blower 82 is directed downwardly into interior space 88 thereby disrupting the flow of air in creating a chaotic flow of air through air tube 84. As fuel is fed through fuel feed inlet 86, the fuel is dispersed and suspended as it is propelled into interior space 78 of combustion chamber 72. The suspension of fuel particles in the flowing air assist in exposing the entire surface area of the fuel particles to improve the combustion of the fuel particles in the combustion chamber 72. Blower 82 is a variable speed blower which may be operated intermittently depending on the performance of various characteristics of the system 10 to optimize the efficiency of the system 10. Operation of the blower 82 will be discussed in further detail below with regard to the operation of the control system 310 of system 10.

Burner assembly 12 further includes an ignition system 96 including an igniter 110 and an air delivery system 98. Ignition system 96 includes an air tube 112 which is in communication with interior space 78 of combustion chamber 72. Both the igniter 110 and aerial delivery system 98 are in communication with interior space 72 through air tube 112. Igniter 110 is a propane fueled burner which delivers a flame to the interior space 78 through air tube 112. Air delivery system 98 includes a blower 114 coupled to air tube 112 and configured to provide a steady flow of fresh air to the interior space 78 of combustion chamber 72. The igniter 110 is operated intermittently depending on the operating characteristics of the system 10 and is controlled by the control system 310 of burner system 10 as will be discussed in further detail below. Ignition system 96 provides is a constant flow of fresh air into combustion chamber 72 at a rate sufficient to cause turbulent flow within interior space 78 which tends to suspend burning particles of fuel. The suspension of the fuel particles enhances the combustion of the fuel particles by exposing all of the surfaces of the fuel particles to the heat within combustion chamber 72, thereby assisting in efficiently burning the fuel particles. It has been found that the efficiency of the burner assembly 12 and effectiveness of burner 12 in achieving a complete burn of fuel particles is directly related to the flow of air within the interior space 78 of combustion chamber 72. It is necessary that ignition system 96 provide sufficient fresh air to provide oxygen for the combustion process as well as provide sufficient airflow for suspending fuel particles. The flow of air required for efficient combustion varies depending on the characteristics of the fuel particles being introduced into the combustion chamber, thereby necessitating the ability to vary the flow of air into interior space 78. As will be discussed in further detail below, the coordination of the fuel feed blower 82 and a mission system blower 114 helps to control the combustion of fuel particles.

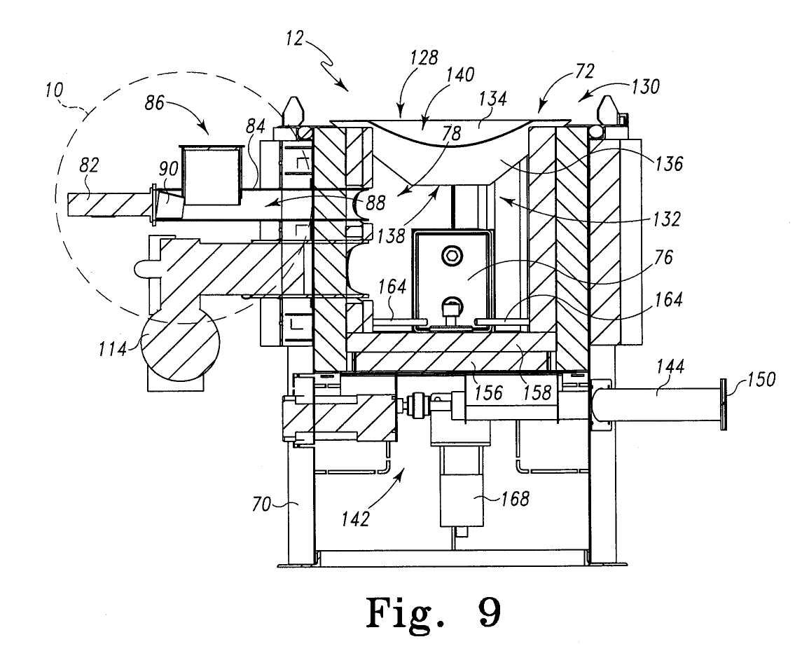

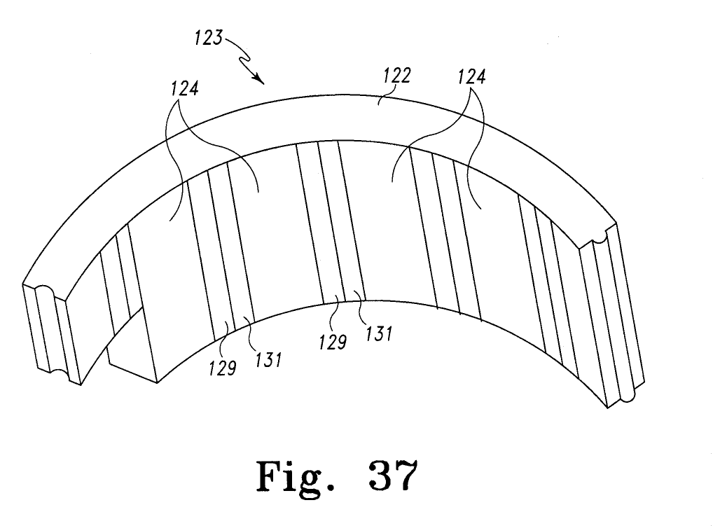

Referring now to FIGS. 9 and 12, combustion chamber 72 includes an inner generally cylindrical wall 116 spaced apart from outer wall 74 with insulation 118 interposed between walls 74 and 116. An additional layer of insulation 120 is positioned between inner wall 116 and a ceramic material 122 which circumscribes the interior space 78 in which combustion occurs. In the illustrative embodiment, the ceramic material is Versaflow 45 Plus castable fireclay based cement available from Harbison-Walker Refractories Ltd. of Wirral, United Kingdom. The ceramic material 122 is cast into 3 pieces 123, 125 and 127 which are assembled to form the ceramic structure within combustion chamber 72. Pieces 123, 125 and 127 of ceramic material 122 are formed to include a plurality of generally planar surfaces 124 which are generally parallel to a vertical axis 126 of burner assembly 12. Referring now to FIG. 37, the generally planar surfaces 124 are separated by generally planar surfaces 129 and 131 which each intersect with an adjoining generally planar surface 131 and 129 respectively to circumscribe the interior space 78. The generally planar surfaces 124, 131 and 129 serve to disrupt the flow of air about the interior space 78 to reduce the laminar flow of air and thereby create a chaotic swirling vortex to suspend fuel particles in the combustion chamber 72. Laminar flow of air about the interior space 78 adjacent the ceramic material 122 tends to allow fuel particles to gather and create groups of fuel particles thereby reducing the exposed surface area of the individual particles.

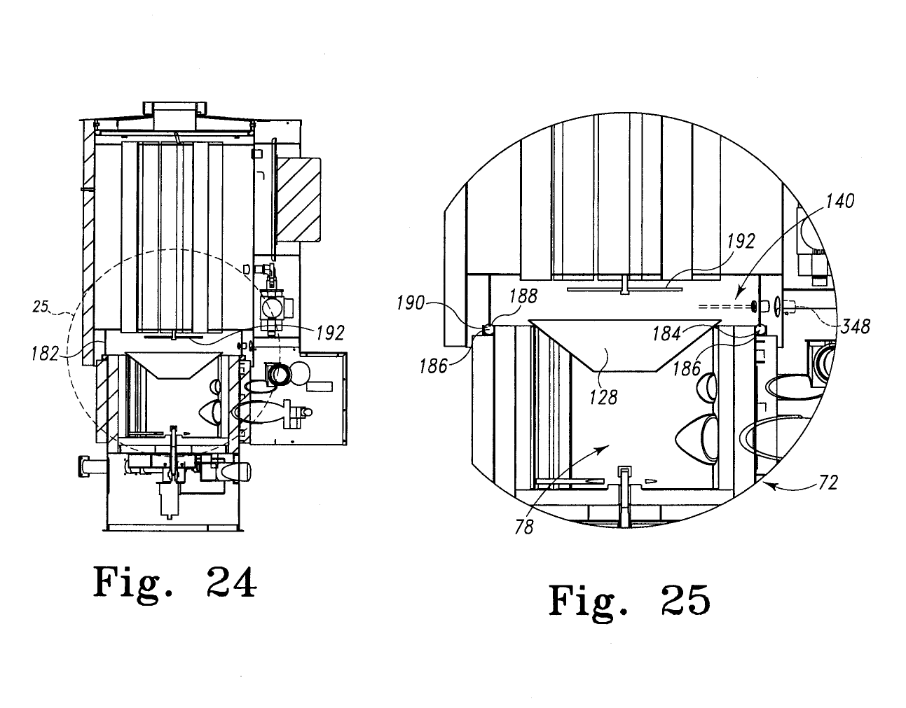

In addition to the disruptive effect of the generally planar surfaces 124 of ceramic material 122, burner assembly 22 includes a cover 128 which is a generally funnel-shaped with the larger diameter of the cover 128 positioned to form an upper end 130 of cover 128. A lower end 132 of cover 128 is positioned into the inner space 78 of combustion chamber 72. A concave surface 134 of cover 128 faces generally vertically upwardly when the cover 128 is positioned on the burner assembly 22. A convex surface 136 of cover 128 faces generally downwardly and forms an upper boundary of interior space 78. A lower aperture 138 of the cover 128 allows for the communication between interior space 78 of combustion chamber 72 to a space 140 between the concave surface 134 and the heat exchanger 16 as shown in FIGS. 24 and 25. Exhaust gases vent through aperture 138 and pass through heat exchanger 16.

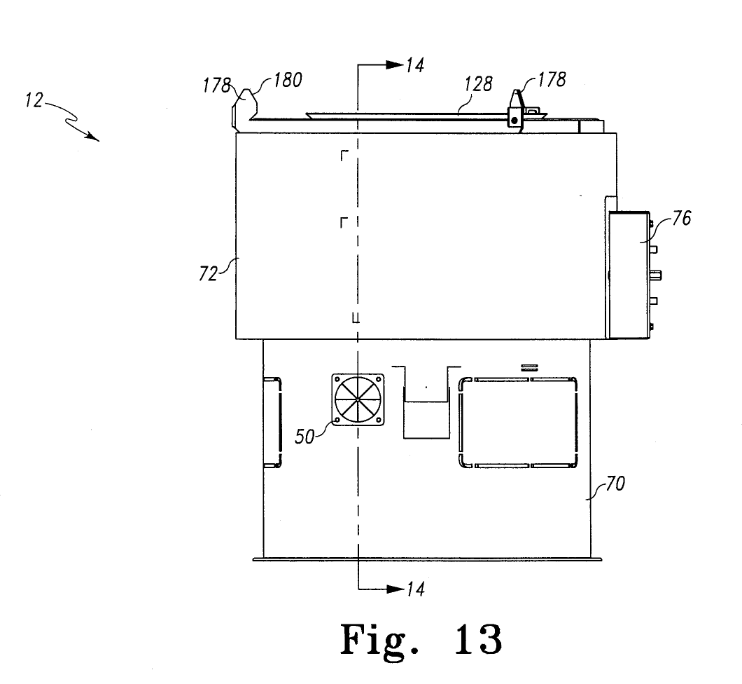

Referring now to FIGS. 13-15, burner assembly 12 further includes an ash auger assembly 142 which includes an auger tube 144 supported by based 22 of burner some 12. An ash auger 146 is positioned within auger tube 144 has driven by an ash auger motor 148. Illustratively, ash auger motor 148 is a 115V, 9.4 RPM, 0.06 HP motor. Ash is communicated to the ash auger 146 through an aperture 170 that communicates from the interior space 78 of combustion chamber 72 through a base 158 comprising ceramic material and a layer of insulation 156 positioned below the base 158 of combustion chamber 72. The ash is accumulated in a space 172 above the ash auger 146 and is conveyed by the ash auger 146 through tube 144 to an outlet 150 which is spring-loaded and biased to a closed position as shown in FIGS. 12 and 13. Ash auger assembly 142 is configured such that an end 154 of ash auger 146 is spaced apart from outlet 150 defining a space 152 between the end 154 and outlet 150. Ash accumulates in the space 152 such that the interior space 78 of combustion chamber 72 is sealed sufficiently to prevent a flow of air through auger tube 144 and aperture 170 into interior space 78. This reduces the chance for chamber 22 of burner assembly 12 to receive back draft through the outlet 150.

Ash which accumulates in the bottom of interior space 78 is stirred by a stir assembly 160 which includes a stirrer hub 162 coupled to a stirrer shaft 166. An ash stirrer motor 168 is position below the combustion chamber 72 within interior space of base 22. In the illustrative embodiment, ash stirrer motor is a part number 6Z073B Dayton brand motor available from Emerson Motor Co. of St. Louis, Mo. Stirrer motor 168 turns stirrer shaft 166 such that arms 164 rotate about the vertical axis 126 of burner assembly 12. Stirring of the ash which accumulates in the bottom of interior space 78 assist with improved combustion by exposing unburned portions of fuel particles to thereby provide additional combustion of the fuel. Additionally, arms 164 urge ash to aperture 170 to feed the ash auger assembly 142 so that ash is not allowed to build up in the combustion chamber 72.

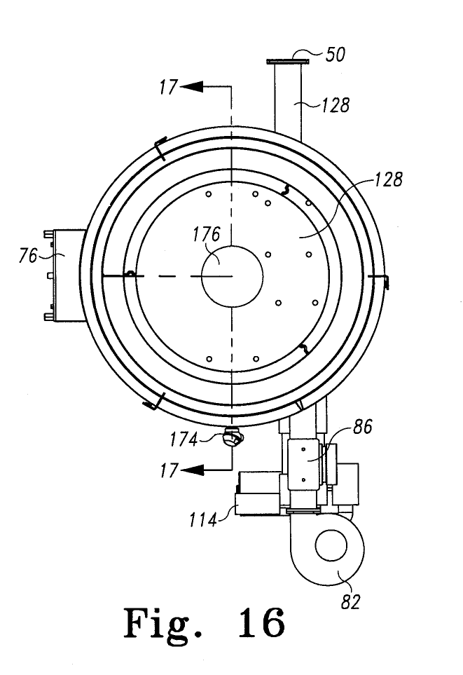

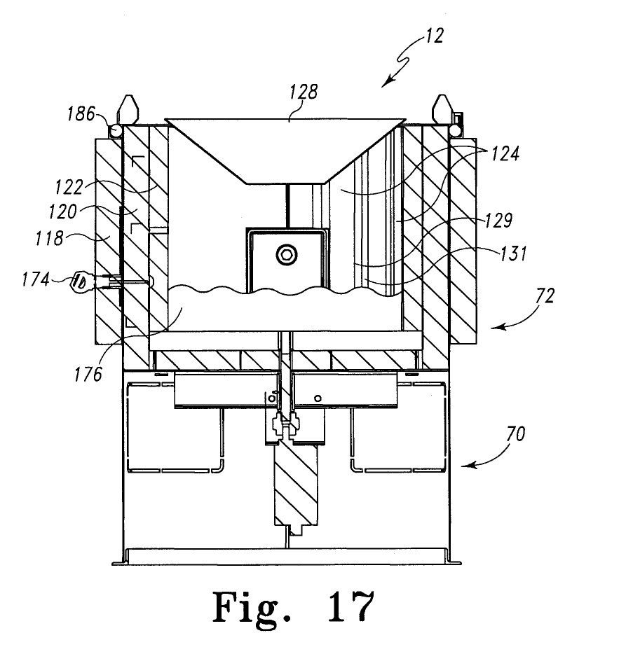

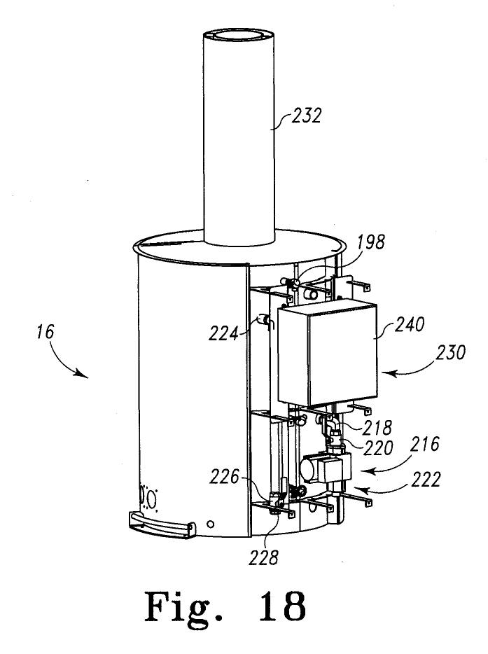

Referring now to FIGS. 16 and 17, burner assembly 12 further includes a thermocouple 174 positioned to monitor the temperature of the ceramic material 122 forming the interior side walls of combustion chamber 72. In the illustrative embodiment, the thermocouple 174 is a part number NB4-CASS-316U-4 type K thermocouple available from Omega Engineering, Inc. of Stamford, Conn. Thermocouple 174 is positioned such that the temperature reading should be taken above a bed of ash 176 and thereby indicative of the air temperature within combustion chamber 72. Thermocouple 174 is used by the control system 310 of burner system 10 in the closed-loop feedback control of the combustion process. By measuring the temperature of the ceramic material 122, the readings from the thermocouple 174 are not subject to variations in the temperature of the air within interior space 78 due to additional flow from blowers 114 or 82. Rather, the temperature of the ceramic material 122 is indicative of a steady-state condition of the temperature in the combustion chamber 72 due to the fact that the temperature of the ceramic material 122 has a response lag due to the mass of the material 122. Therefore, the control system 310 is not subjected to swings in the temperature reading from the ceramic material 122.

As heat is generated in burner assembly 12, it rises through heat exchanger 16 to heat fluid which is pumped through heat exchanger 16. The fluid pumped through heat exchanger 16 may be used for various purposes including domestic hot water heat, for example. Heat exchanger 16 is supported on burner assembly 12 and retained in place by a number of brackets 178 which are coupled to the wall 116 of burner assembly 12. Each bracket 178 has a surface 180 which engages in inner wall 182 of heat exchanger 116 such that heat exchanger 116 is centered on burner assembly 12 when positioned thereupon. A lower edge 184 of wall 182 rests upon a rope seal 186 which circumscribes the an outer surface 188 of wall 116 such that the rope seal 186 is positioned in an circular bracket 190 to retain the rope seal 186 against surface 188. The rope seal 186 prevents the escape of exhaust gases from burner assembly 12 through the interface between the heat exchanger 16 and burner assembly 12.

The exhaust gases from burner assembly 12 exit the burner assembly and impinges upon a plate 192 to distribute the gases through several heat exchanger tubes 194 that pass through a vessel 196 through which a fluid such as water or oil is pumped. The exhaust gases heat the walls of the tubes 194 and the heat is conducted to the fluid in vessel 196. The plate 192 distributes the heat such that it passes through all of the tubes 194 to improve the heat transfer between the gases and the fluid in the vessel 196. Vessel 196 is fluid tight and the temperature of the fluid in the vessel 196 is monitored by a thermocouple 210 which extends through a wall 212 of vessel 196 and into an interior space 214 in which fluid is circulated around tubes 194. The temperature of the fluid sensed by thermocouple 210 is processed by the control system 310 during the closed-loop feedback control of the burner system 10.

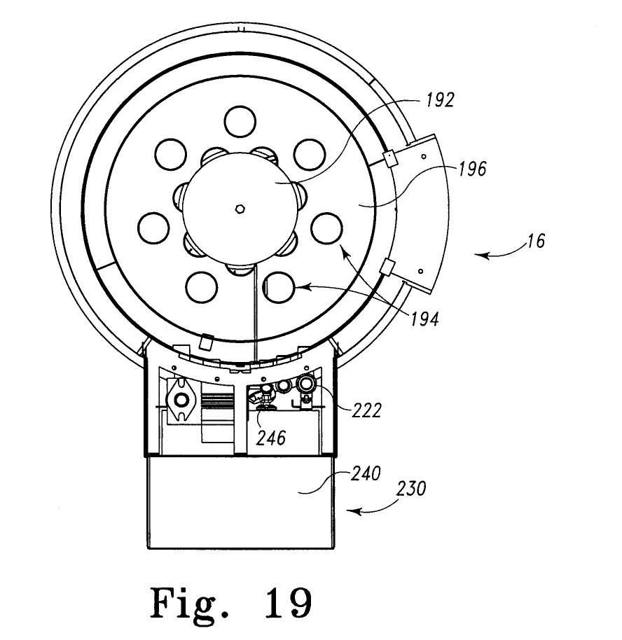

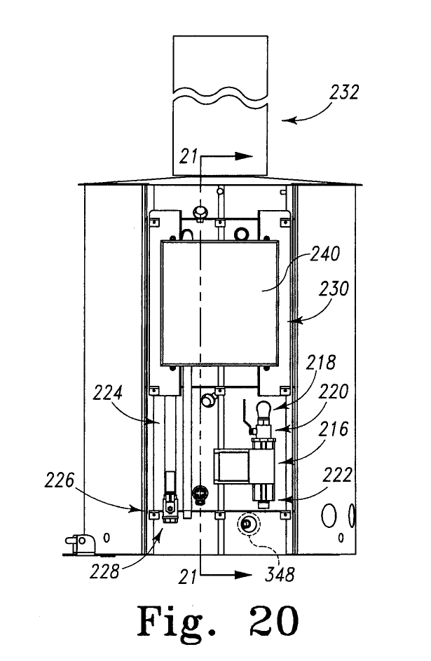

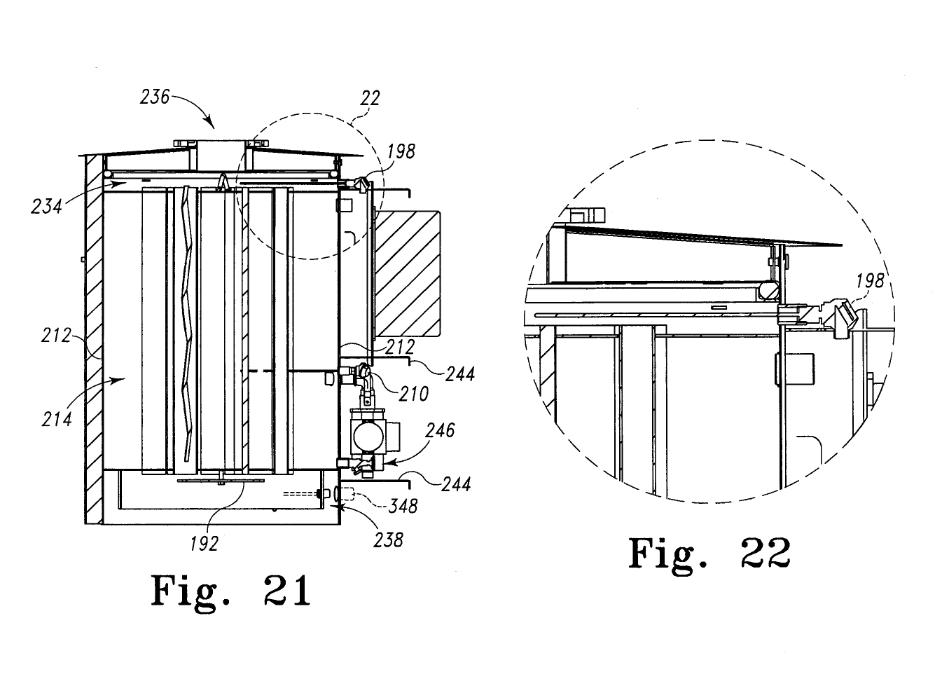

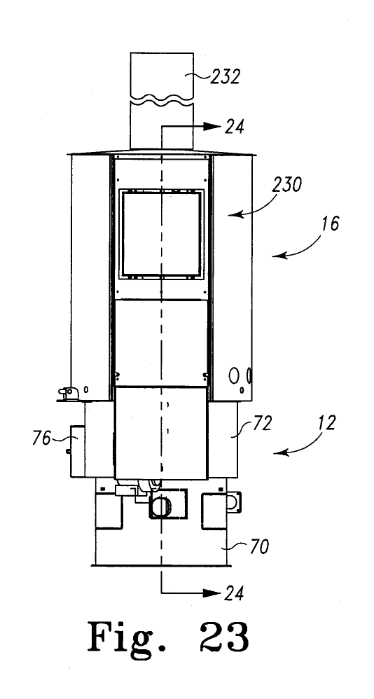

Referring to FIGS. 18-22, the fluid in the vessel 196 is circulated by a pump 216. In the illustrative embodiment, pump 216 is a part number 0013-F3 pump available from Taco, Inc. of Cranston, R.I. Pump 216 is in fluid communication with the interior space 214 of vessel 196 through a conduit 218. A coupler 222 is coupled to pump 216 and configured to couple pump 216 and, thereby, vessel 196 to and a fluid volume external to the system 10. A valve 220 is coupled to conduit 218 and pump 216 and is closable to isolate the fluid in vessel 196 from the pump 216 for repairs or to permit the vessel 196 to be connected to a different external fluid volume. A second conduit 224 is in fluid communication with the interior space 214 of vessel 196. A valve 226 is coupled to conduit 214 and a coupler 228 is coupled to valve 226, similarly to valve 216, valve 226 isolates vessel 196 from an external fluid volume which may be coupled to coupler 228. Fluid flows to an external fluid volume through one of the conduits 218, 224 and returns to the vessel 196 through the opposite of the two conduits 218, 224. A fluid tap 246 is positioned at the lower end of vessel 196 to permit vessel 196 to be drained.

Further monitoring of the operation of the system 10 by control system 310 is accomplished by the monitoring of the exhaust temperature of gases which have passed through the heat exchanger 16. A thermocouple 198 is positioned in a space 234 above the vessel 196 and measures the temperature of the air in the space 234 as part of the closed-loop feedback control of system 10. Air exits heat exchanger 16 through an exit 236 and a chimney 232. The relationship of the temperature of the air in space 234 and fluid in vessel 196 is used to determine whether additional fuel should be added to the combustion chamber 72 or additional air should be introduced by one of the blowers. The exhaust temperature measured in space 234 is also indicative of safety issues with system 10.

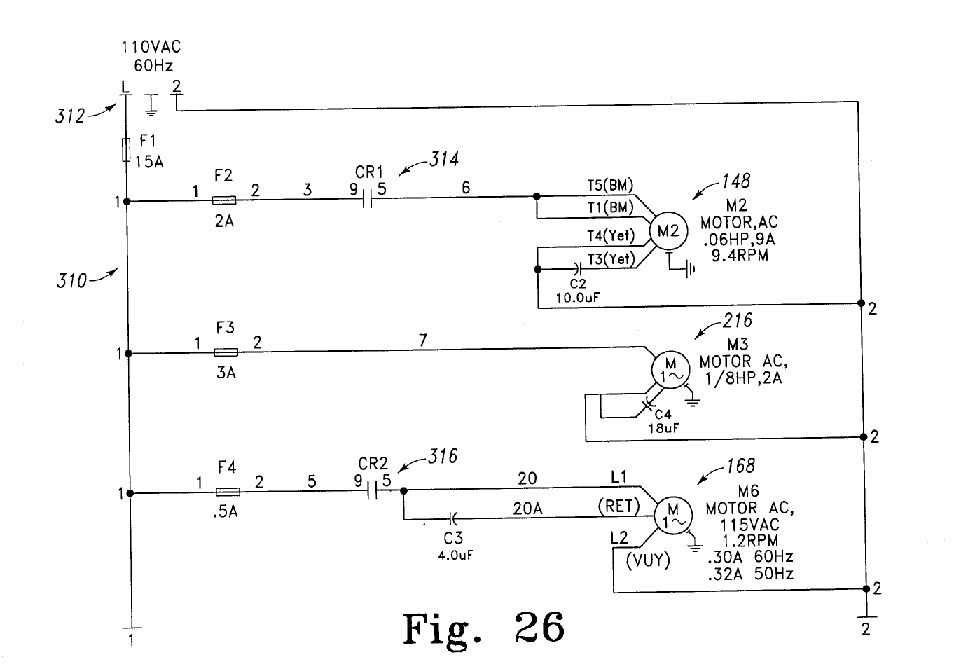

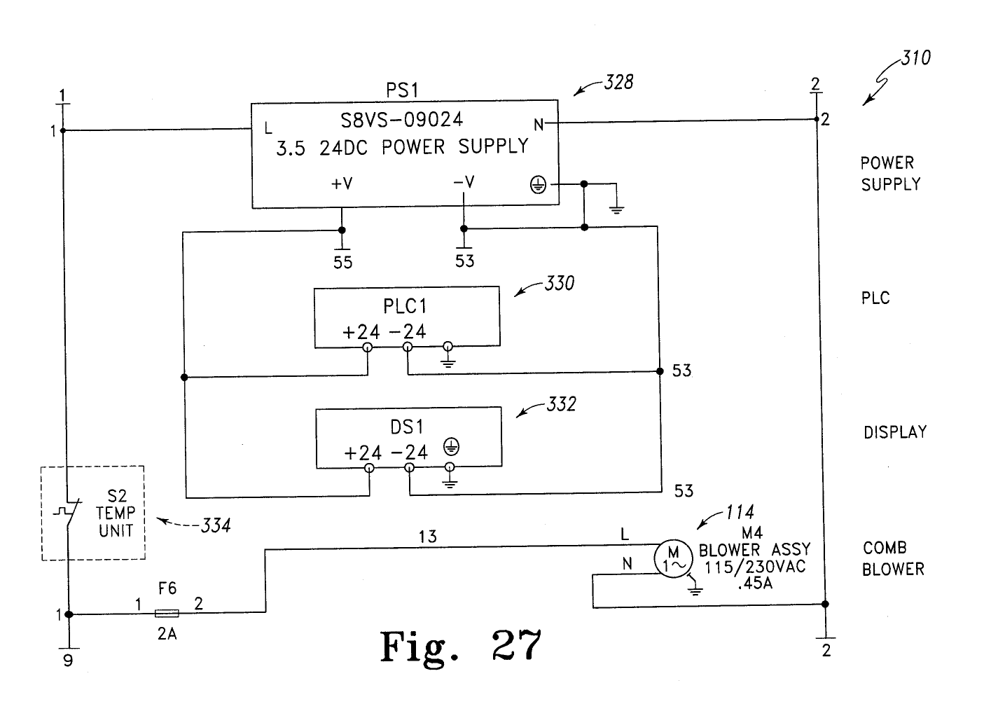

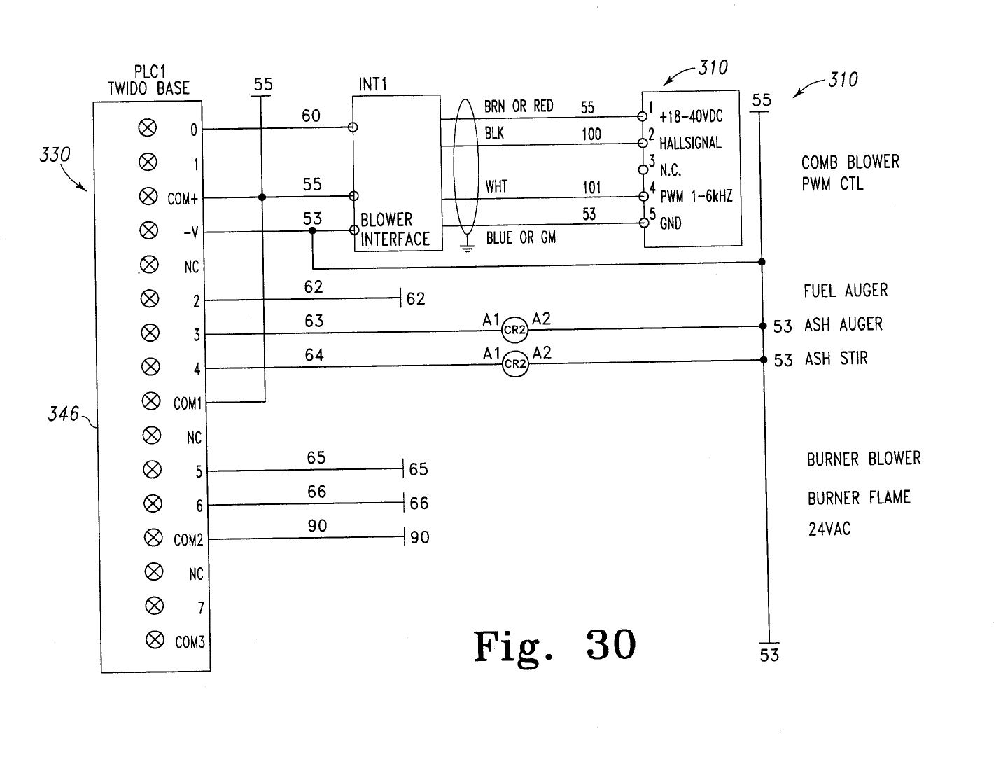

Control system 310, shown schematically in FIGS. 26-32, includes a programmable logic control (PLC) 330 which is software driven to automatically control the operation of system 10 based on operation parameters entered by a user. The system 10 can optionally be programmed by a user to operate to certain conditions, or a user can select several pre-programmed recipes for operation in which control variables for the system have been predetermined for various fuel types and conditions.

Control system 310 is configured to be powered by mains power 312. In the illustrative embodiment, mains power 312 is 110 VAC at 60 Hz. It should be understood that control system 10 may be configured at any of a number of AC power configurations as necessary for operation in varying locales. Mains power 312 powers a DC power supply 328 which powers various DC powered components of control system 310 including the PLC 330 and a display 332. The PLC 330 of the illustrative embodiment is a part number TWDLMDA20DRT Twido PLC available from Schneider Automation, Inc. of Andover, Md. The display of the illustrative embodiment is a 24VDC color graphic display part number XBTGT2330 also available from Schneider Automation, Inc. of Andover, Md.

As shown in FIG. 27, control system 310 includes a thermal switch 334 that is opened in the case of a thermal safety issue. The switch is positioned in the heat exchanger 16 and cuts power to the control system 310 components if the heat exchanger 16 temperature rises to an unacceptable level. Ash auger motor 148 and ash stirrer motor 168 are under the operation of the PLC 330 to operate intermittently. A switch 314 controlled by the PLC 330 turns ash auger motor 148 on and off. Similarly, a switch 316 turns ash stirrer motor 168 on and off.

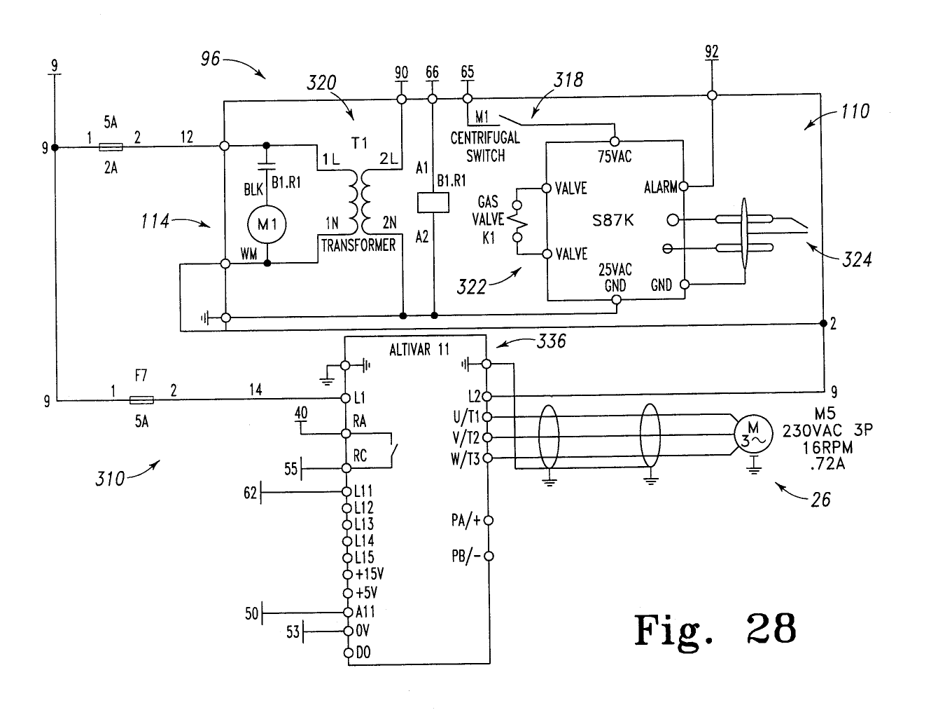

The ignition system 96 shown in FIG. 28 includes blower 114 under control of the PLC 330 and the igniter 110. Illustratively, the ignition system 96 is a part number 63365 available from Wayne Combustion, Inc. of Fort Wayne, Ind. Igniter 110 includes a gas valve 322 which controls the flow of propane to the igniter 110 and a spark generator 324. The igniter 110 is controlled by the PLC 330. A safety switch 318 disables the operation of igniter 110 if blower 114 is not operational. Based on the control parameters under which the PLC 330 is operating, the ignition system 96 may operate with only the blower 114 or the igniter 110 may be operated to introduce additional heat into the combustion chamber 72.

The operation of the fuel feed motor 26 is controlled by a motor controller 336 which is under control of the PLC 330 and operable to turn the fuel feed motor 26 on and off and to control the speed of motor 26 as needed to feed the combustion chamber 22. In the illustrative embodiment, the motor controller 336 is a part number ATV11HU05F1U Telemechanique brand controller available from Schneider Electric, Inc. of Andover, Md.

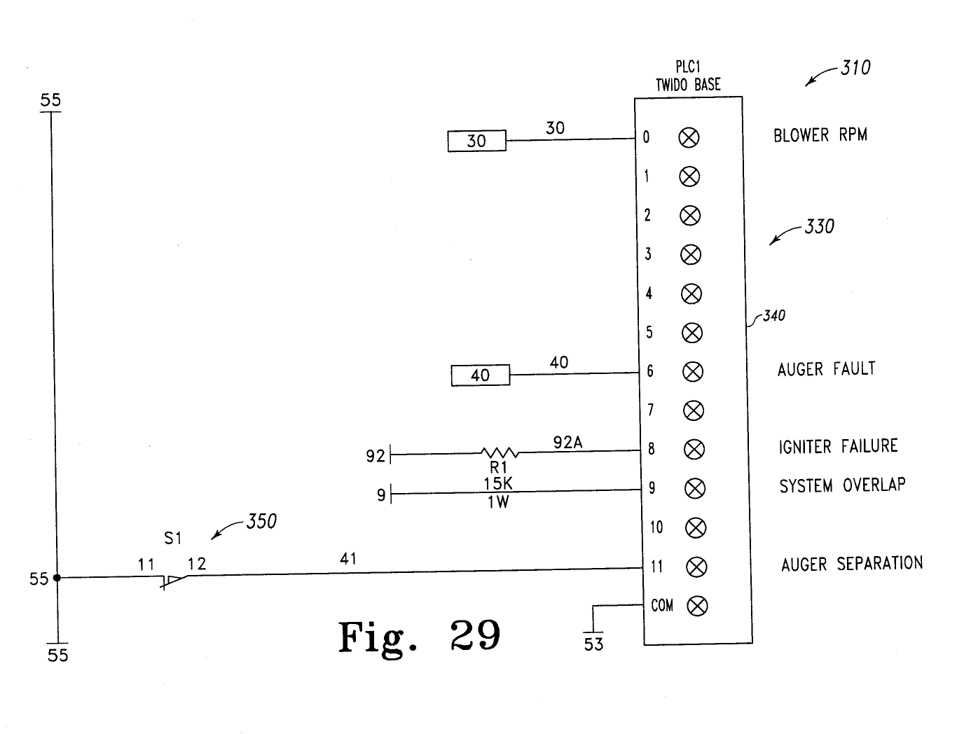

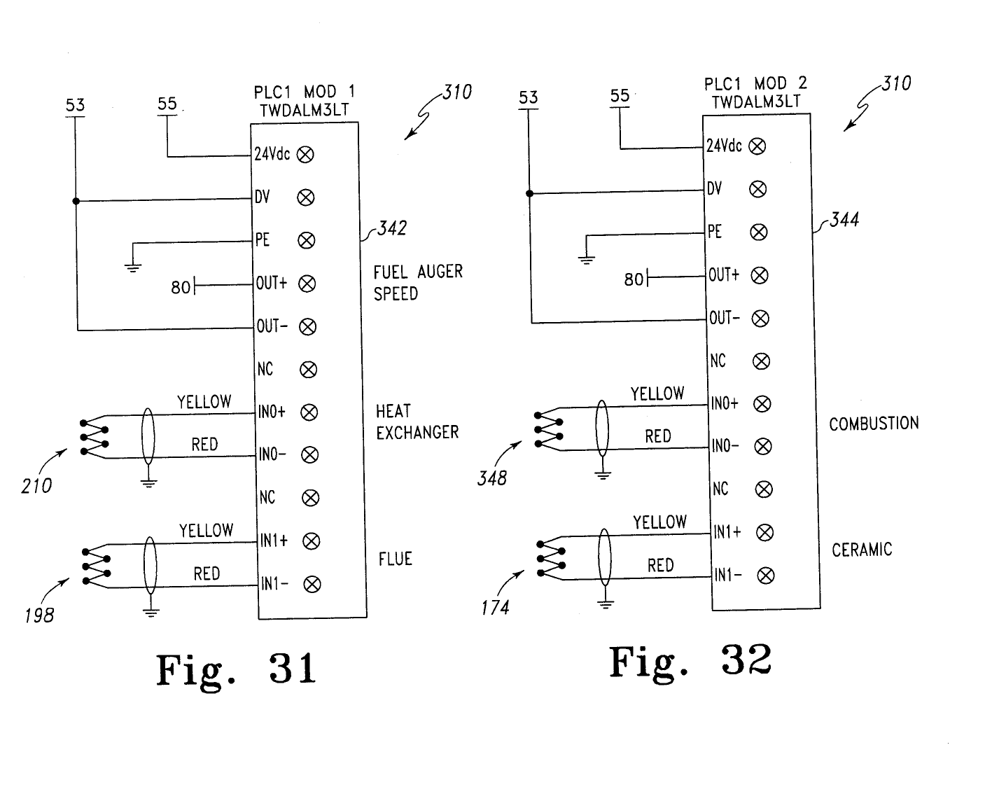

The PLC 330 includes multiple input modules 340, 342 and 344 as shown in FIGS. 29 and 31. In the illustrative embodiment, modules 342 and 342 are part number TVDALM3LT Twido brand thermocouple modules available from Schneider Automation, Inc. of Andover, Md. In addition, an output module 346 controls the operation of the various components under PLC 330 control. Specifically, the blower 56 is under the control of PLC 330 through a blower interface 338 which monitors the speed of blower 56 and pulse width modulates the blower 56 motor to control the blower 56.

The temperature of the various components of system 10 as measured by the thermocouples 174, 198, 210 and 348 received by the PLC 330 to make operational decisions. Thermocouples 198 and 210 measuring the exit air and heat exchanger temperatures respectively, are input into input module 342. Similarly, the ceramic material 122 temperature is input into input module 334. In some embodiments, an additional thermocouple 348 (shown in phantom in FIG. 25) may be positioned to measure the temperature in the inner space 40 between combustion chamber 72 and heat exchanger 16. The temperature measured by thermocouple 438 is input to the PLC 330 through the input module 344.

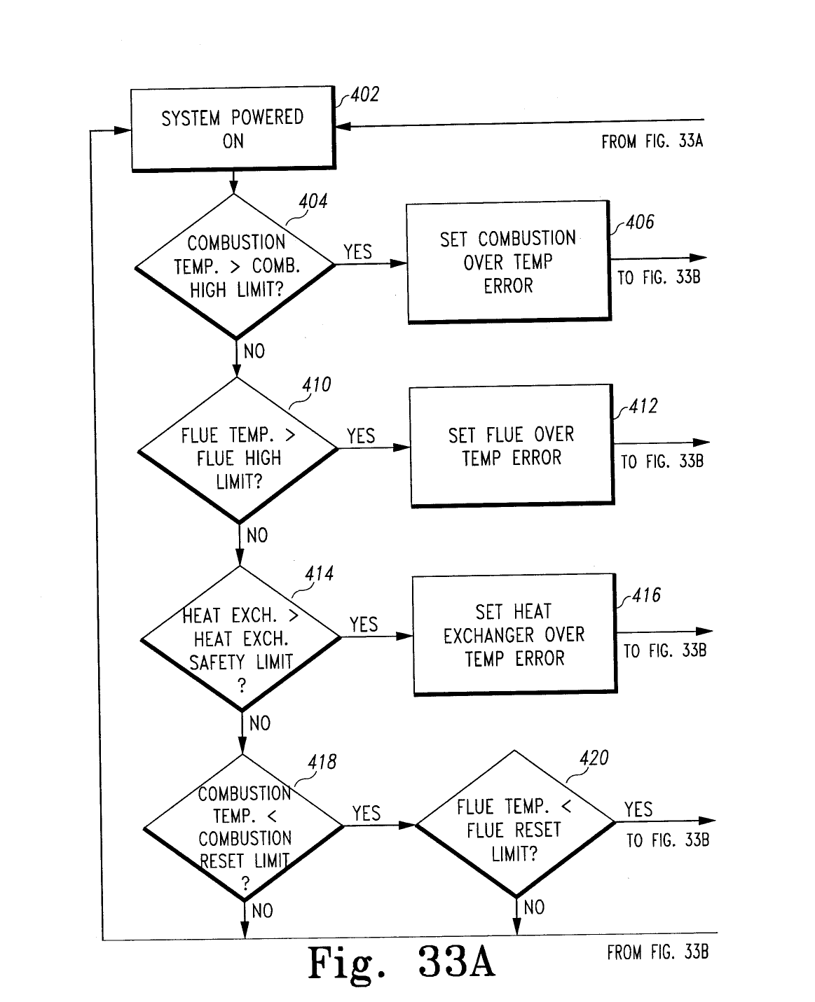

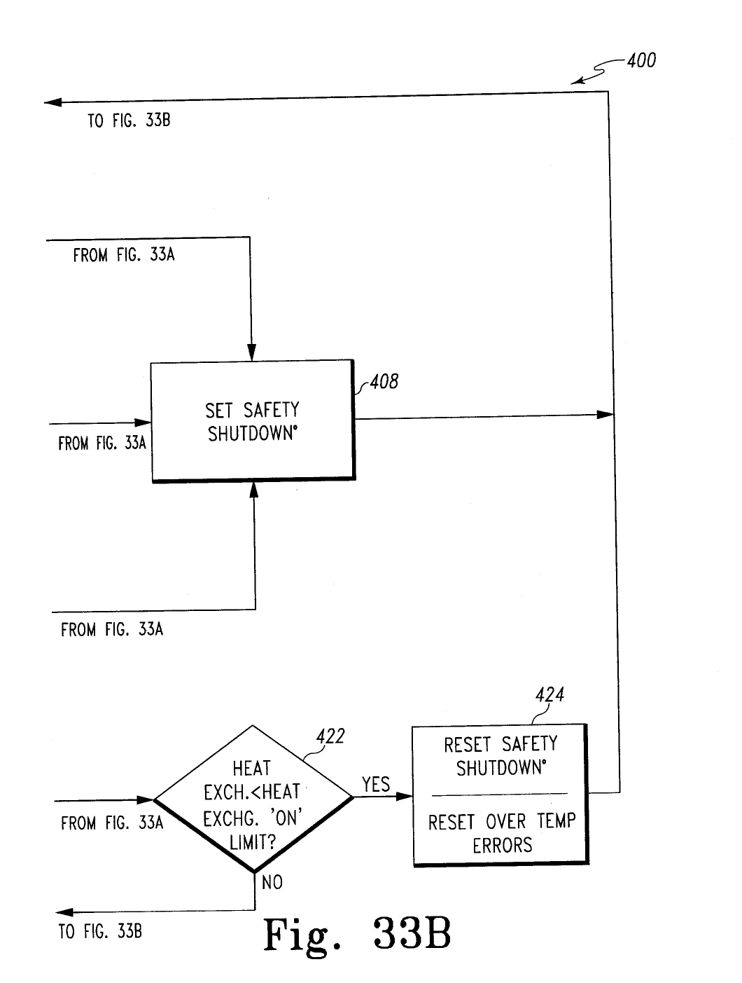

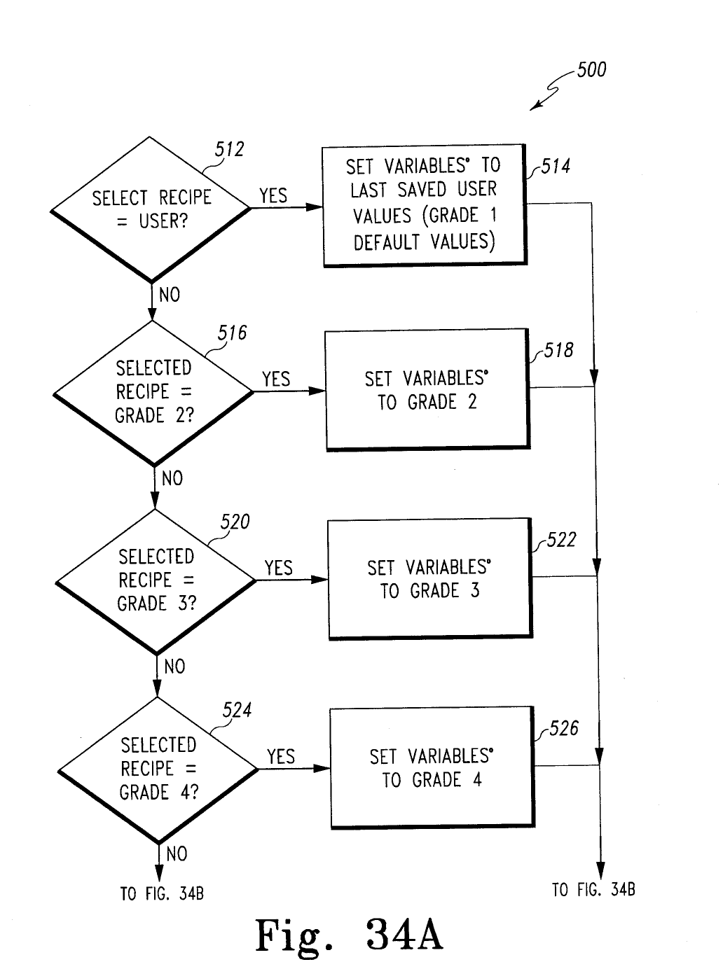

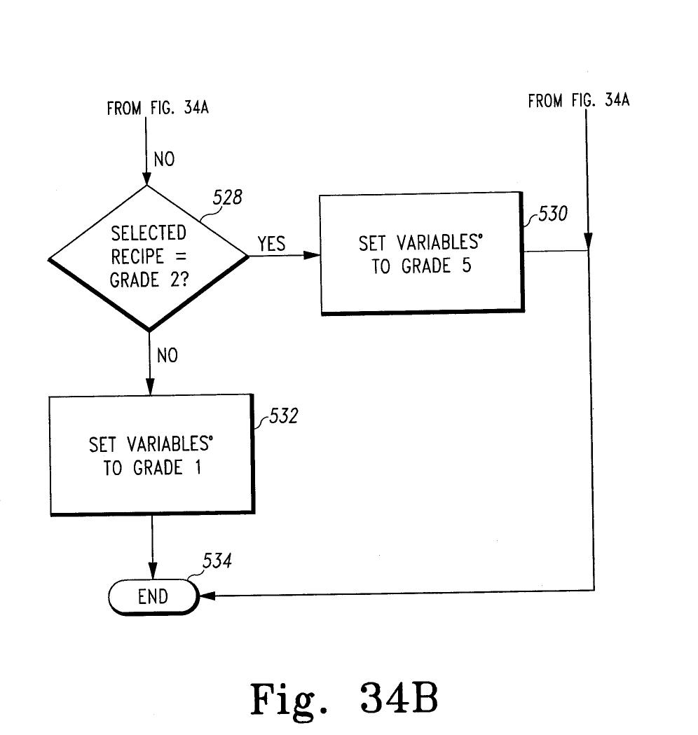

PLC 330 is operable to control system 10 by monitoring the various inputs and controlling the various outputs shown in FIGS. 26 through 31. PLC 330 is programmed to both operate system 10 in a safe manner and to operate system 10 in an efficient manner. The monitoring of conditions for safety is illustrated in the flowchart shown in FIG. 33 in which a control routine 400 commences when the power to the system is turned on at step 402. At decision step 404, routine 400 determines if the combustion temperature is greater than a high limit set by a user or the particular program being employed by the user. If the combustion temperature is greater than the high limit, control routine 400 commences to step 406 and sets the combustion temperature error. Once the combustion temperature error is set the control routine 400 progresses to step 408 where the system is placed in a safety shutdown mode. In the safety shutdown mode the system inhibits the fuel feed motor 26, the combustion blower 82, and the igniter blower 114.

If the combustion temperature does not exceed the high limit at step 404, control routine 400 progresses to step 410 which is a decision step which evaluates the exit air temperature measured by thermocouple 198 and compares that temperature to a high limit. If the exit air temperature is greater than the high limit then control routine 400 progresses to step 412 where the flu over temperature error is set and routine 400 progresses to step 408 wherein system 10 placed in safety shutdown mode. Similarly, if the temperature evaluated at step 410 does not exceed the high limit, control routine 400 progresses to step 414. Step 414 is a decision step wherein the temperature of the heat exchanger as measured by thermocouple 210 is compared to the safety limit. If the heat exchanger temperature exceeds the safety limit the control routine 400 progresses to step 416 wherein the heat exchanger over temperature error is set. Control routine 400 and advances to step 408 to commence the safety shutdown of system 10.

If the system 10 is not experiencing any over temperature conditions then control routine 400 advances to step 418 where the combustion temperature is compared to a combustion temperature reset limit. If the combustion temperature is less than the combustion temperature reset limit then the control routine 400 advances to step 420 where the exit air temperature is compared to a reset limit temperature. If the temperature at step 420 is less than the reset temperature limit for exit air, then the control routine advances to step 422. At step 422 the heat exchanger temperature is compared to a heat exchanger on limit temperature setting to determine if the exchanger temperature is less than the limit temperature. If the heat exchanger temperature is less than the limit, then the control routine 400 advances to step 424 wherein the safety shutdown condition is reset as the system 10 is in a safe condition. If any of the temperatures measured at steps 418, 420, or 422 are greater than the respective limits, then the control routine 400 advances to step 402 without resetting the safety shutdown condition.

While control routine 400 continuously monitors the temperature conditions within system 10 to assure that system 10 operates at a safe temperature in the various components, a user may choose a pre-programmed recipe depending on the type and condition of a fuel or may choose to select a user defined operating condition as depicted by the flowchart in FIG. 34. A control routine 500 shown in FIG. 34 commences when a user chooses the recipe select routine at step 510. Control routine 500 then advances to step 512 where it is determined whether or not a user has selected a user-defined recipe. If the user selects the user-defined recipe at step 512, the operating variables are set to the last saved user variables. At initial startup, a set of default values for grade 1 fuel is the default operating parameter configuration of the system 10. The predefined operating recipes of the control system 310 are established based no various fuel conditions identified by grades. A grade 1 fuel is a relatively dry, small-particle fuel such as dry sawdust.

Operational variables which may be set by a user or defined in a recipe include parameters defining a stable temperature, a self igniting temperature, and initial start temperature. Additionally, a user may define the temperature at which fuel is run, the rate at which fuel is run, a fuel start rate, and a fuel turndown rate. Efficient combustion requires control of both fuel and air flow. A user may also define an error start rate, an error run rate, and an error turndown rate to optimize the flow of fuel in the flow of air into the combustion chamber 72. As different fuels produce ash at different rates, the operational parameters of the ash auger 142 varying the operation time of the ash auger 142 may also be set by a user. The user is also able to toggle on and off a self igniting feature of the system 10 in which the igniter may be turned on to add additional heat to the combustion chamber 72 if needed.

If the user does not select the previously identified user variables at step 512, then control routine 500 progresses to step 516 where it is determined if a user has selected the recipe associated with grade 2 and if so, the grade 2 variables are set at step 518. At step 520 it is determined if the user has selected a recipe associated with grade 3 fuel. If grade 3 is selected, grade 3 variables are set at step 522. Otherwise control routine 500 advances to step 524 or it is determined if the user has selected a recipe associated with grade 4. If grade 4 is selected at step 524, the grade 4 variables are set at step 526. Otherwise, control routine 500 advances to step 528 where it is determined if the user has selected the recipe associated with grade 5. If grade 5 is selected, grade 5 variables are set at step 530 or if the recipes associate with grade 5 has not been selected, the variables associated with grade 1 are set at step 532. Once a recipe is selected, control routine 500 advances to step 534 where the recipe selection routine is ended.

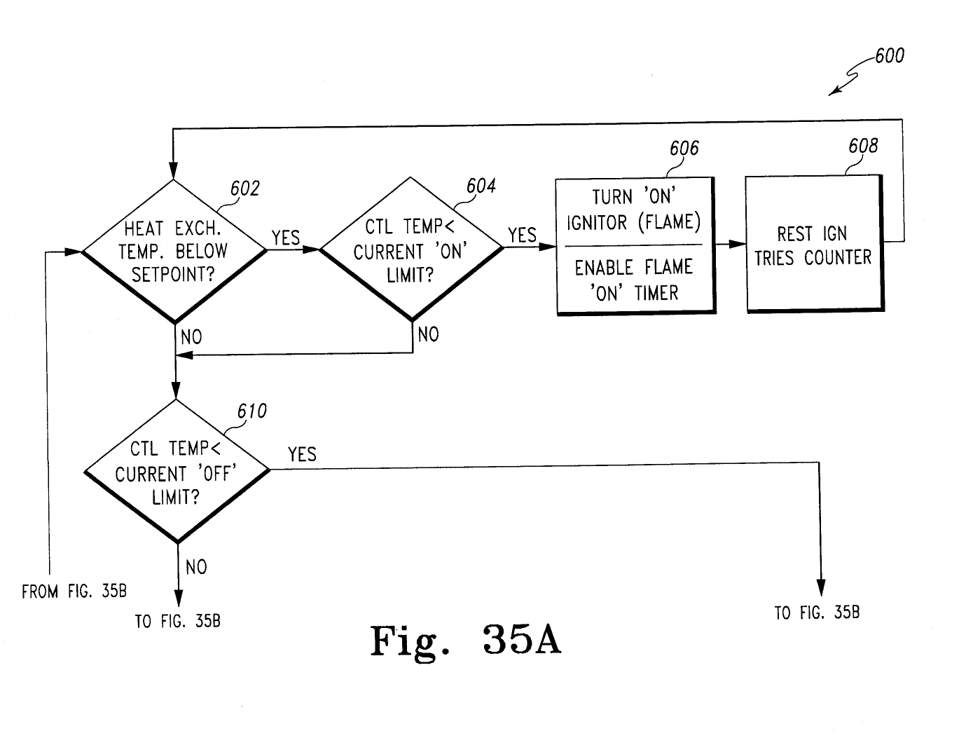

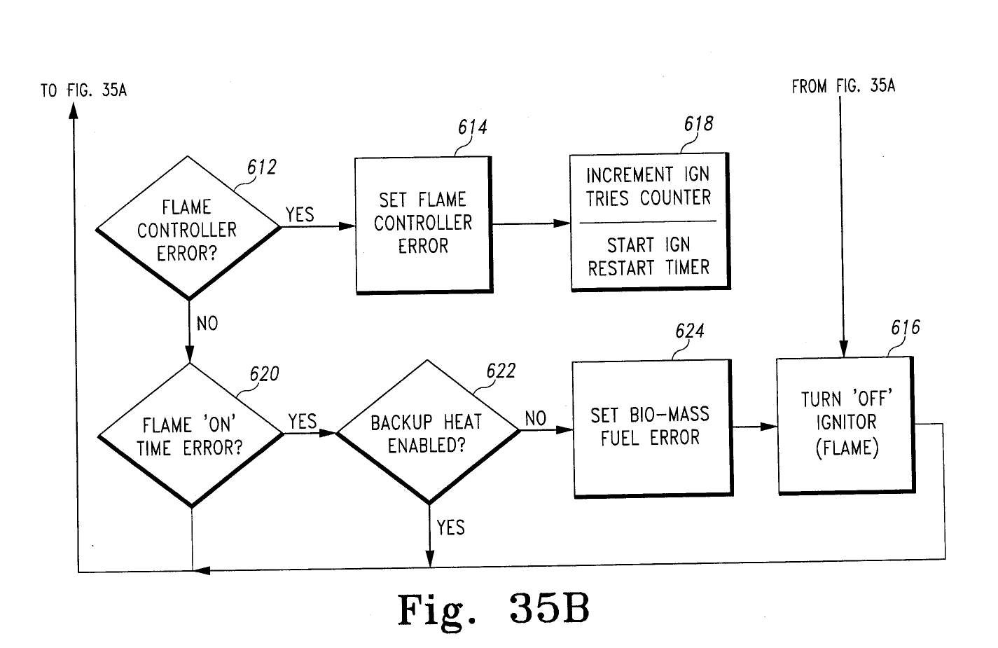

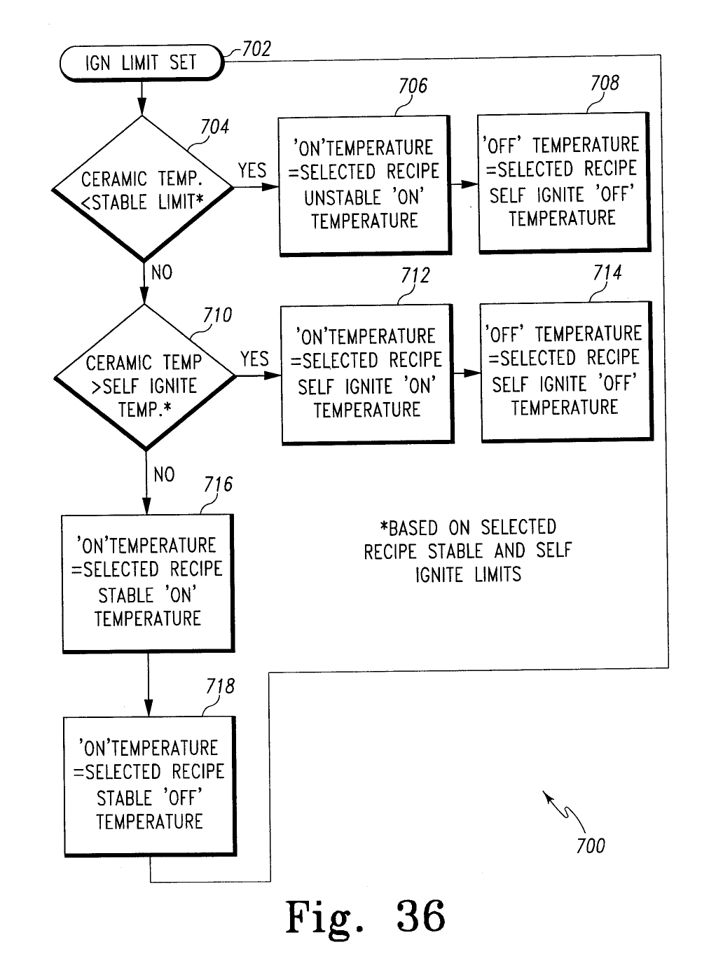

Once a recipe has been selected, operation of the system 10 occurs according to the variables set within the recipe selected. However, in some instances the operating parameters set by the recipe may fail to provide sufficient heat for the heat exchanger 16. The temperature of the heat exchanger is monitored within control routine 600 shown in FIG. 35. At step 602 of control routine 600 the heat exchanger temperature is compared to a set-point. If the heat exchanger temperature is below the set-point then control routine 600 advances to step 604 wherein the control temperature is compared to the on limit for the igniter 110. If the temperature is less than the igniter on limit then control routine 600 advances to step 606 where the igniter 110 is turned on to supplement the heat in system 10 in an effort to bring the temperature within the heat exchanger 16 to an acceptable level. When the igniter is turned on at step 606, a flame on timer is commenced so that the time in which the igniter 110 is on can be monitored. From step 606 control routine 600 advances to step 608 wherein the mission tries counter is reset.

If the heat exchanger temperature is above the set-point as determined at step 602 or the control temperature is greater than the on limit for the igniter 110 at step 604, control routine 600 advances to step 610. At step 610 the control temperature is compared to an off-limits for the igniter. If the control temperature is greater than the off-limits then control routine 600 advances to step 616 where the igniter is turned off. If the control temperature is not greater than the off-limits at step 610, control routine 600 advances to step 612 where it is determined if there is a flame controller error. If there is flame controller error then control routine 600 advances to step 614 where there is a flame controller error set. Control routine 600 then advances to step 618 where the ignition tries counter is incremented and an ignition restart timer is started. Control routine 600 then advances to step 616 and turns the igniter 110 off. If there is no flame controller error at step 612 then control routine 600 advances to step 620 to determine if the flame on timer has reached an error condition. If the error condition is determined at step 620 then control routine 600 advances to step 622 or is determined if backup heat is enabled. If backup heat is enabled, then the igniter is allowed to continue to operate and the control routine returns to step 602. However, if backup heat is not enabled within the operating parameters of the system 10, then the control routine 600 advances to step 624 where a biomass fuel error is set indicating that there is an error with the introduction of biomass fuel into the system 10. Control routine 600 then advance us to step 616 where the igniter 110 is turned off in order to maintain the system 10 in a safe condition.

The control of the igniter 110 within control routine 600 is effective to provide supplemental heat to system 10. In control routine 700 shown in FIG. 36, the ignition limits are set commencing at step 702. Control routine 700 advances to step 704 where the ceramic material 122 temperature is compared to a stable limit. The stable limit is defined by the selected recipe. If the ceramic material 122 temperature is less than the stable limit at step 704 then control routine 700 advances to step 706 where the on temperature for the igniter is set to the unstable on temperature of the selected recipe. Control routine 700 then advances to step 708 where the off temperature of the igniter is set to the unstable off temperature of the selected recipe and then the control routine 700 loops back to step 702. In the situation where the ceramic material 122 temperature is less than the stable limit as determined at step 704, the parameters for operation of the igniter 110 are defined in order to bring the ceramic material 122 temperature up to a stable limit which should improve the efficiency of the burner assembly 12 by having sufficient heat in the interior space 78 of combustion chamber 72 to cause fuel introduced into the interior space 78 to self ignite without the need for the operation of the igniter 110. If it is determined at step 704 that the ceramic material 122 temperature is not less than the stable limit, then control routine 700 advances to step 710 where it is determined whether the ceramic material 122 temperature is greater than the self ignite temperature as defined by the selected recipe. If the ceramic material 122 temperature is greater than the self ignite temperature, then control routine 700 advances to step 712 where the on temperature for the igniter 110 is set to the selected recipe self ignite on temperature. Control routine 700 and advances to step 714 where the off temperature is set to be selected self ignite off temperature of the recipe and control routine 700 loops back to step 702. If it is determined at step 710 that the ceramic material 122 temperature is not greater than the self ignite temperature, control routine 700 advances to step 716 where the on temperature for the igniter is set to the stable on temperature of the selected recipe and then the off temperature is set to the selected stable off temperature at step 718. Thus, control routine 700 varies the temperature at which igniter 110 operates based on the temperature of the ceramic. The temperature of the ceramic has been found to be directly related to the efficiency of the combustion within the combustion chamber 72. The igniter 110 is effective to raise the temp of the ceramic material 122 to achieve the stable temperature for the ceramic material 122.

Although certain illustrative embodiments have been described in detail above, variations and modifications exist within the scope and spirit of this disclosure as described and as defined in the following claims.

1. A biomass burner assembly comprising
a combustion chamber including a base and a generally cylindrical wall extending vertically from the base, the generally cylindrical wall defining a generally vertical axis, the generally cylindrical wall and the base cooperating to define a combustion space,
a first air tube configured to communicate air from outside of the combustion chamber to the combustion space, the first air tube including a longitudinal axis oriented in a generally horizontal plane, the first air tube positioned such that the longitudinal axis of the first air tube is parallel to a line that intersects the generally vertical axis of the generally cylindrical wall, the first air tube spaced horizontally apart from the generally vertical axis of the generally cylindrical wall,
a first blower coupled to the first air tube and configured to provide a variable flow of air through the first air tube to the combustion space,
a second air tube configured to communicate air from outside of the combustion chamber to the combustion space, the second air tube including a longitudinal axis oriented in a generally horizontal plane, the second air tube positioned such that the longitudinal axis of the second air tube is parallel to a line that intersects the generally vertical axis of the generally cylindrical wall, the second air tube spaced horizontally apart from the generally vertical axis of the generally cylindrical wall,
a second blower coupled to the second air tube and configured to provide a variable flow of air through the second air tube to the combustion space,
a nozzle positioned in the second air tube and configured to disrupt the flow of air in the second air tube to create a generally chaotic air flow, and
a fuel feeder coupled to the second air tube and positioned to introduce fuel to the second air tube at point where the flow of air has been disrupted by the nozzle.

2. The burner assembly of claim 1, wherein the burner assembly further comprises a generally funnel-shaped cover, the cover positioned such that an end of the generally funnel-shaped cover having a larger diameter is supported on the generally cylindrical wall of the combustion chamber and a smaller diameter of the generally funnel-shaped cover is positioned in the combustion space, the smaller diameter defining an aperture through which exhaust gases are vented.

3. The burner assembly of claim 1, wherein an interior portion of the generally cylindrical wall is lined with a ceramic material.

4. The burner assembly of claim 3, wherein an interior surface of the ceramic material is formed to include a plurality of generally planar surfaces, each generally planar surface generally parallel to the axis of the generally cylindrical wall and each generally planar surface intersecting an adjacent generally planar surface such that the interior generally vertical surface of the combustion chamber is a discontinuous surface.

5. The burner assembly of claim 1, wherein the burner assembly further comprises a controller operable to control the speed of the second blower and wherein the controller is operable to control the fuel feeder to vary the mass of fuel fed to the combustion chamber.

6. The burner assembly of claim 5, wherein the burner assembly further comprises a sensor positioned adjacent the generally cylindrical wall, the sensor operable to provide a signal indicative of the temperature of the generally cylindrical wall to the controller.

7. The burner assembly of claim 1, wherein the base if formed to include an aperture.

8. The burner assembly of claim 7, wherein the burner assembly further comprises an ash auger.

9. The burner assembly of claim 8, wherein the aperture in the base communicates between the combustion space and the ash auger such that the ash auger is operable to remove ash from the combustion chamber.

10. The burner assembly of claim 9, wherein the ash auger operates intermittently.

11. The burner assembly of claim 10, wherein the ash auger is configured to maintain ash in the auger to prevent air from flowing through the ash auger into the combustion chamber.

12. The burner assembly of claim 8, wherein the burner assembly further comprises a controller operable to control the operation of the ash auger.

13. The burner assembly of claim 11, wherein the ash auger is configured to maintain ash in the auger to prevent air from flowing through the ash auger into the combustion chamber.

14. The burner assembly of claim 8, wherein the burner assembly further comprises an ash stirrer configured to rotate within the combustion chamber to expose uncombusted fuel and move ash to the aperture in the base.

15. The burner assembly of claim 14, wherein the burner assembly further comprises a controller operable to control the operation of the ash auger and the ash stirrer.

16. The burner assembly of claim 15, wherein the ash auger and the ash stirrer are intermittently independently activated by the controller.

17. The burner assembly of claim 16, wherein the ash auger is configured to maintain ash in the auger to prevent air from flowing through the ash auger into the combustion chamber.

18. The burner assembly of claim 1, wherein the flow of air from the first and second air tubes creates a vortex flow about an inner surface of the generally cylindrical wall of the burner assembly.

19. A control system for a biomass burner system including a burner assembly including a interior ceramic wall and an exhaust gas exit, a fuel feed storage system configured to provide a variable flow of biomass fuel to the burner assembly, and a heat exchanger including (i) tubes through which the exhaust gases from the burner assembly flow, (ii) a vessel through which a fluid is circulated to receive heat from the tubes, and (iii) a gas exit, the control system comprising:
a first temperature sensor for measuring a temperature at the exhaust gas exit of the burner assembly,
a second temperature sensor for measuring a temperature of the ceramic wall,
a third temperature sensor for measuring a temperature of the fluid in the heat exchanger,
a fourth temperature sensor for measuring a temperature of the exhaust gas at the gas exit of the heat exchanger,
an ignition system including a burner and a variable speed combustion blower for providing combustion air to the combustion chamber,
a variable speed fuel feed blower for propelling a flow of fuel to the combustion chamber, and
a variable speed fuel feed motor for providing a fuel to the variable speed fuel feed blower.

20. The control system of claim 19, wherein the control system is operable to measure the temperature of the ceramic material and to start the burner of the ignition system if the ceramic temperature is below a predetermined set-point temperature.

21. The control system of claim 19, wherein the control system is operable to measure the temperature of the heat exchanger fluid and to vary the flow of fuel to the combustion chamber by varying the speed of the fuel feed motor.

22. The control system of claim 20, wherein the control system is further operable to vary the speed of the fuel feed blower to vary the flow of fuel to the combustion chamber.

23. The control system of claim 19, wherein the control system is operable to compare the temperature sensed by each of the first, second, third, and fourth temperature sensors to respective safe limit temperatures and to stop the flow of fuel, the flow of combustion air, and the operation of the ignition system if any of the temperatures exceed a respective safe limit.

24. The control system of claim 19, wherein the control system is configured to allow a user to select a predefined operating routine based on characteristics of the fuel being used and to control the operation of the biomass burner system based on the parameters of the operating routine.

25. A biomass burner system comprising
a burner assembly including a combustion chamber, first and second air tubes in communication with the combustion chamber, a first blower coupled to the first air tube and configured to provide a variable flow of air to the combustion chamber, a second blower coupled to the second air tuber and configured to provide a variable flow of air to the combustion chamber,
a fuel storage assembly coupled to the burner assembly and configured to provide a flow of fuel to the second air tube, the fuel storage assembly including a fuel storage hopper, a fuel auger in communication with the fuel storage hopper and configured to convey fuel from the fuel storage hopper to the second air tube of the burner assembly,
a heat exchanger supported on the burner assembly, the heat exchanger including a plurality of tubes communicating through the heat exchanger and configured to communicate exhaust gases from the burner assembly through the heat exchanger, a flue in communication with the plurality of tubes and configured to exhaust the exhaust gases, the heat exchanger further including a fluid reservoir including an inlet and an outlet through which a fluid material is passed, the fluid material receiving heat through the walls of the tubes through conduction, and
a controller operable to coordinate the operation of the blowers and the fuel auger to maintain combustion of the fuel in the combustion chamber.

26. The biomass burner system of claim 25, wherein the burner assembly further comprises a burner in communication with the combustion chamber to ignite the fuel and burn the fuel.

27. The biomass burner system of claim 26, wherein the controller is operable to control the burner.

28. The biomass burner system of claim 27, wherein the burner is a propane burner.

29. The biomass burner system of claim 26, wherein the burner assembly further comprises an ash auger and an ash stirrer.
